(19) United States
(12) Patent Application Publication
(10) Pub. No.: US 2026/0271845 A1
(43) Pub. Date: Sep. 17, 2026

(54) ENCLOSED HIGH-DENSITY FARMING ENVIRONMENT AND SYSTEM

(71) Applicant: HELIPONIX, LLC, Evansville, IN (US)

(72) Inventors: Scott Thomas Massey, Evansville, IN (US); Ivan Lee Ball, Owensville, IN (US)

(21) Appl. No.: 19/469,505

(22) PCT Filed: Apr. 16, 2024
(86) PCT No.: PCT/US24/24715

§ 371 Date: Sep. 26, 2025

Related U.S. Application Data
(60) Provisional application No. 63/496,529, filed on Apr. 17, 2023.

(51) Int. Cl. A01G 31/02; A01G 31/00

(52) U.S. Cl. CPC A01G 31/025; A01G 31/011

(57) ABSTRACT

An indoor farming environment for the cultivation of plants and other vegetation. The indoor farming environment may include a plurality of planting towers, each with multiple receptacles for receiving seed cartridges. The indoor farming environment may provide nutrients, fluids, and light based on specific characteristics of each individual plant being cultivated and include robotic systems for planting, pruning, and harvesting.

### CROSS-REFERENCE TO RELATED APPLICATIONS

This application is a U.S. national stage application under 35 USC § 371 of International Application No. PCT/US24/24715 filed on Apr. 16, 2024 and entitled “ENCLOSED HIGH-DENSITY FARMING ENVIRONMENT AND SYSTEM, which claims priority to U.S. Provisional Application No. 63/496,529 filed on Apr. 17, 2023, and entitled “ENCLOSED HIGH-DENSITY FARMING ENVIRONMENT AND SYSTEM,” the entire contents of which are incorporated herein by reference.

### BACKGROUND

Today, the growth and popularity of enclosed or indoor farming is rapidly increasing. This growth of the enclosed farming industry has allowed for the production of high-quality fresh produce in regions having climates that are unsuitable or poorly suited for traditional farming. However, conventional indoor farming techniques and systems have high energy and capital costs and are typically limited to a low variety of crops, as the conventional indoor farming techniques are unable to adequately accommodate differing growth conditions required to produce a large variety of produce. Additionally, conventional indoor farming techniques typically require a highly skilled labor force that are trained in both farming techniques and use of advanced technologies, which are often inaccessible in the regions that could benefit most from the enclosed farming industry.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example pictorial diagram of a system associated with an indoor farming environment according to some implementations.

FIG. 2 is an example pictorial diagram of a portion of an indoor farming environment according to some implementations.

FIG. 3 is an example pictorial top down diagram of an indoor farming environment according to some implementations.

FIG. 4 is an example pictorial diagram of an indoor farming environment according to some implementations.

FIG. 5 is an example pictorial diagram of a portion of an indoor farming environment according to some implementations.

FIG. 6 is an example system that may implement the techniques described herein according to some implementations.

FIG. 7 is an example pictorial diagram of an interior of the enclosed growing environment with one or more seed cartridges in various stages of germination according to some implementations.

FIG. 8 is another example pictorial diagram of an interior of the enclosed growing environment with one or more seed cartridges in various stages of germination according to some implementations.

FIG. 9 is an example pictorial diagram of an interior of the indoor farming environment with a heat displacement system having incorporated lighting system according to some implementations.

FIG. 10 is an example pictorial diagram of a module including a pair of planting towers with associated portion of a combined lighting and heat displacement system 1006 according to some implementations.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Discussed herein are systems and methods associated with automating, optimizing, and customizing enclosed farming environments and systems to allow for cultivation of a large variety of produce with reduced labor skills compared with conventional indoor farming in a highly compact or dense manner. For example, the systems, discussed herein, may be configured to provide an enclosed farming environment for indoor cultivation of produce (e.g., crops, fungi, flowers, mushrooms, herbs, fruits, sprouts, shoots, other plants, and/or the like). The system may, in some implementations, provide an isolated enclosure that is configured to provide stable and controlled environmental conditions, physically separated from the conditions within a surrounding environment (e.g., the outdoor environment surrounding the enclosed farming environment).

In some examples, the enclosed farming environment may be configured with multiple planting towers or columns configured to receive one or more seed cartridges via one or more receptacles, receiving slots, or cavities. For example, each of the planting towers may comprise a plurality of receptacles configured to receive individual seed cartridges or pods. The planting receptacles may be arranged both in vertical columns and horizontal rows about the planting tower. For instance, in one specific example, the planting tower may include 10 columns and 21 rows of planting receptacles. As another implementation, in one specific example, the planting tower may include 14 columns and 28 rows of planting receptacles. In some cases, the planting receptacles may be staggered between the columns and adjacent columns, such that each column has one planting slot for every other row. In these cases, staggering the planting receptacles allows the system to be able to monitor conditions of each individual plant and provide individualized nutrition (lighting conditions, water supply, and nutrients) as well as allowing each individual plant sufficient room to grow. As other examples, the towers may be configured such that the system includes three columns, eight rows, and twenty-eight rings tall. In some cases, the columns and rows may be staggered or spaced differently to allow for improved plant growth, human access, and robotic access. As one alternative example, the tower may include smaller rings (e.g., five receptacle rings, seven receptacle rings, or the like). In some examples, the number of columns, rows, rings, or receptacles per ring may vary based at least in part on a target crop(s) to be grown.

In some implementations, the environment or system may include between 10 and 40 planting towers. In other implementations, the environment or system may include between 20 and 25 planting towers. In one specific example, the environment or system may include 24 planting towers (e.g., 5,040 receptacles or plants per system). For example, the system may include three rows with each row including eight planting towers. In other implementations, the environment or system may include between 30 and 35 planting towers. For instance, the environment or system may include 32 planting towers, e.g., the system may include four rows with each row including eight planting towers (e.g., 6,720 receptacles or plants per system).

In some cases, the planting towers may be rotatable three-hundred and sixty degrees within the enclosure and about a base, or any other limited rotation. For example, a drive motor may be configured to mechanically or magnetically rotate the planting tower within the enclosure based on one or more control signals from a monitoring and control system. In some instances, as the planting towers rotates, each individual planting receptacle of each individual planting tower may be assigned a unique identifier, such that the system is able to monitor and track each seed cartridge and resulting plant based on a determined location within the planting towers and the enclosed environment. The planting towers may also be coupled to a water reservoir that is configured to provide water to the seed cartridges on, for example, an individualized basis.

In some examples, the seed cartridge may be specifically designed to mate and/or otherwise be received within a cavity defined by the slot of the planting towers. The seed cartridges may be a self-contained apparatus having an exterior structure of one or more surfaces or walls that contain one or more seeds suspended in one or more layers of substrate or growing medium. For example, in some cases, the substrate or medium may include a first or bottom layer of fertilizer (such as slow release fertilizer prills). A second layer over the fertilizer that is composed of an open cell polyurethane foam (e.g., a compostable polyurethane foam). In some cases, the second layer may be included to separate the seeds from the fertilizer prills, wick water upwards to seeds, provide a foundation for root growth, and drain water downwards, so the cartridge does not become oversaturated and generate undesirable anaerobic/aerobic microbial growth. Additionally, the second layer may prevent root burn and/or damage from the higher concentrations of nitrates in the fertilizer prills. In some instances, the second layer may be a single solid media to prevent the seeds from becoming translocated throughout the substrate during transport and, thereby, not growing out top of the cartridge as desired. As an alternative example, the second layer may be a PLA fiber growing media. In some instances, the media of the second layer is dark colored or black so as to not reflect light and thereby prevent algae growth.

In some cases, the seeds may be positioned, as a third layer, above the second layer. The seeds may be suspended in a foam or other solid and compostable media plug. In some cases, the plug may be thermally and/or mechanically formed inserts having a size to match the size of the seeds. A fourth layer may be positioned above the seed layer and/or third layer. The fourth layer may include a loose growing media placed over the seeds. The growing media may be loose for the seedlings to grow through as the foliage cannot pass through a solid or tightly packed media. In some cases, the loose growing media may include paper fiber. The paper fiber may be configured to become saturated and retain moisture to ensure good germination rates of the seeds.

In some examples, the seed cartridge may include a removable top surface, a bottom surface parallel to the top surface, and a side wall or surface. For example, the top surface may be peelable or otherwise removable such that during transport and handling the top surface may act as a lid to maintain the substrate, seeds, and/or other medium within the cartridge. The top surface may then include a tap or extended portion that may be gripped, by for instance a user inserting the cartridge into the planting tower, and then separated, peeled, or otherwise removed from the cartridge to allow the plant to sprout from and extend upward from the substrate within the cartridge. The lid may be partially sealed permanently and partially sealed temporarily, so that the lid (with the plant identifier) remains partially attached to the seed pod cup even if a significant portion of the lid was opened to allow for plant growth.

In some cases, the tap or extended portion may include at least two flat sides or portions, such that the seed cartridge does not roll, experience longitudinal rotation, or otherwise slide on flat surfaces, such a table or counter, or during transport and shipping. For instance, in one example, the tab may be formed in a substantially triangular shape in which the apex of the triangle is extended from the base which couples to the exterior side surface.

In some examples, the side surface may be substantially coned shaped to provide a larger top surface when compared with the bottom surface. However, it should be understood that the exterior surface of the seed cartridge may take various forms and/or shapes, such as substantially rectangular prisms, substantially triangular prisms, substantially pyramidal, and the like.

The seed cartridge may include one or more openings, holes, or slits along the exterior side surface to allow water to be delivered from the planting tower to the seeds and/or substrate within the seed cartridges. The slits may be arranged in columns along the side surface and the columns may extend substantially the entire width of the exterior side surface, such that the slits are located along substantially the entire width of the cartridge. In some examples, the size of the slits may vary in size or length (as measured from the top surface to the bottom surface of the cartridge) with respect to each other. For instance, lower slits may be both longer relative to higher slits as well as closer together (e.g., the distance between the slits is reduced). In some cases, the columns of slits may also become closer to each other (e.g., the horizontal or width wise gaps between the slits may be reduced) as the slits approach the bottom surface (e.g., slits proximate to the bottom surface are closer horizontally and vertically to other slits than slits proximate to the top surface). In some examples, the slits may continue along the bottom surface of the seed cartridge. For example, the lowest slit in each column may partially extend into the bottom surface of the seed cartridge to provide improved drainage during use.

In this manner, the slits concentrically approach near, or at the center of the cartridge as the slits approach the bottom surface of the cartridge. The concentrically designed slits improve upon other traditional seed delivery containers by comparatively directing root growth downwards and increasing the plants and seeds access to water and nutrients contained in the lower sections of the cartridge. Additionally, the concentrically designed slits of the seed cartridge provide for easier manufacturing and, in particular, injection molding of the cartridges. In some examples, the slits may be configured with rounded corners and the corners may be equipped with filets to add structural integrity to the carriage during use and to assist with the flow of the liquid polymer or other material that is injected into a mold during manufacturing.

In some cases, the system or environment may include an access panel or area that allows for an operator to access at least a portion of one of the planting towers for the insertion of seed cartridges into receptacles and/or the harvesting of plants upon maturation. For example, the planting towers may be mounted on a movable track, such that the planting towers may move (positionally relative to each other and the environment) as well as rotate in place as desired for providing customized or individualized nutritional requirements (such as lighting). In this manner, the operator may utilize the access area to plant and harvest produce as desired. In some cases, the access area may be a door or panel that allows for access to an adjacent planting tower, while in other examples, the access area may be an aisle between rows and/or columns of planting towers. In still other examples, the access area may include a region that allows for access of multiple planting towers but less than full access to all planting towers (e.g., the operator may access a subset of the planting towers). In some cases, the access area may include or be adjacent to an isolation foyer or area that includes an entry door between the indoor environment and the exterior and a flexible door or strip curtain may be used behind the entry door to limit outside environment exposure.

In some examples, the indoor farming environment and system may be configured for self or robotic harvesting and planting. In these examples, the indoor farming environment and system may be closed in such a manner that the operator may be unable to access the internal systems during normal use. In this manner, space used for the access area may be converted into areas designed to grow additional plants, thereby increasing yields and the system may prevent unwanted pests, pathogens, and air entry into the indoor environment. In these examples, a robotic arm (such as a multi-axis robotic arm) or other system may be configured to utilize computer vision to receive, grasp, and insert seed cartridges into designated planting receptacles. In some cases, the robotic system may be associated with a track that may be positioned, for instance, along a top surface of the interior of the environment, to allow the robotic system to move within the environment.

The robotic arm or other system may be also configured to utilize computer vision to identify, harvest, prune, pollinate, and otherwise remove plants from the planting tower and deliver the plants to a collection area, where the plants may be removed from the system. For example, the system may operate as a vending machine that receives seed cartridges and outputs plants. In some cases, the input area and the collection area may include multiple doors that may open and close to prevent outside air, dust, pests, pathogens in the like from entering the indoor environment. In some cases, an access chamber may open a first door to receive a seed cartridge, close the first door, remove (e.g., such as via a vacuum) or otherwise treat (introduce pesticides or the like) or clean the chamber via a water or other spray, and open a second door (associated with the indoor environment) to allow the robotic system to plant the seed cartridge. Likewise, a similar process may be performed in reverse when harvesting plants.

In various implementations, the environment and system may include sensors (such as humidity sensors, temperature sensors, thermal, and the like as well as image devices including infrared sensors, red-green-blue sensors, ultraviolet light (UV) sensors, and the like) to track and/or monitor each individual plant or receptacle within the system. The system may also be equipped with various light sources or illuminators (e.g., infrared light illuminators, visible light illuminators, UV light illuminators, and the like), water systems, environmental control systems (e.g., heating systems, cooling systems, humidity systems, and the like), and nutrient providing systems. In this manner, unlike conventional indoor farming systems that provide uniform lighting, temperature, water, and other environmental conditions, the environment and system, discussed herein, may provide active monitoring and adaptive environmental conditions for individual plants based on the health, stage of growth, type or species of plants, and the like.

For instance, in some specific implementations, the system may be configured to monitor individual plant(s) within the indoor farming environment and to provide tailored growing conditions, such as custom lighting (e.g., length of exposure via tower rotation, tilt, and/or angular positioning/orientation, focal length, temperature, specific wavelengths, intensity, amount, and the like) for each plant or receptacle. In some cases, the individual growing conditions may be based on a detected or determined health, size, and/or stage of growth or reproduction of an individual plant within the receptacle in addition to the type or species of the individual plants. Further, the indoor farming environment may be used to induce post-harvesting dying conditions at the end of the plants' growth cycle.

In some cases, each of the planting receptacles may have a visible marking or invisible marking (e.g., an infrared spectrum mark) that the system may read upon insertion of a seed cartridge. In other cases, the indoor farming environment and system may determine that a receptacle has been filled as the planting towers rotate based on a known geometry, relative position of towers, known position of the tower, and the like. In some cases, markings for location determination may also be placed at various positions about the surfaces of the planting towers to assist with initialization or location determination upon restart or reboot of the system as well as in response to an upgrade or replacement lighting and control column being installed or calibrated.

In some implementations, a lighting and control system may be configured within the indoor farming environment or along a specific region of the indoor farming environment. The lighting and control systems may be equipped with various sensors for monitoring the individual plants. For example, the lighting and control systems may be equipped with one or more sensors, such as image devices (e.g., red-green-blue image devices, infrared image devices, x-ray, monochrome image devices, lidar devices, radar devices, and the like), humidity sensors, temperature sensors, air pressure sensors, carbon dioxide (CO2) sensors, spectral sensors, and the like. The lighting and control column may also be equipped with one or more illuminators (such as visible lights, infrared illuminators, ultraviolet lights, lasers, projectors, and the like). The illuminators may be adjustable to provide specific spectrums, amounts of light, and intensities of light to each individual planting receptacle based on the corresponding plant's health, life stage, size, and type or species.

In some cases, the lighting and control systems may also include multiple sensors and/or illuminators in various combinations and including duplication. In some implementations, a field of view or a region of interest associated with each of the sensors and/or illuminators that may be adjustable such that a single sensor (or set of sensors) and/or illuminator (or set of illuminators) may, respectively, capture data and provide light to multiple planting receptacles while maintaining individual per plant spectrum, amount, and intensity characteristics.

In some examples, the lighting and control systems may include arrays (such as of LEDs) mounted vertically with respect to the planting towers to illuminate the planting towers in parallel to a central vertical axis of individual planting towers. In one example, as plants within a tower mature or otherwise grow and a diameter of the planting tower increases (e.g., the tower plus corresponding vegetation), the LED arrays or illuminator arrays may gradually move towards a corner of the planting tower's radius and rotate towards the central axis of the planting tower. In this example, the system may maintain a closest, most proximate, or nearest distance between the plants of the planting tower and the illuminator arrays without compromising an allowable growth radius of the plants of the planting tower. In some cases, the movement or rotation may be based on a time (e.g., clock or timer based on a planting of the receptacles of the planting tower), a detected size, life stage, health, of the plants or presence of flowers or fruits (e.g., via computer vision techniques, as discussed herein). The rows of towers may be in a sequential order that maximizes the number of towers within a chamber.

As one specific example, the illuminator array may be controlled by the computer vision system of the indoor farming environment, such that the array's radial angle and lateral position per individual tower is adjusted based on the detected characteristics of the plants of the individual tower. The angle desired to illuminate the plants is towards the central axis of the planting tower and is known relative to a lateral position of the arrays, the radial angle and lateral position per individual tower may be maintained by, in one example, a geared ratio adjusting the rotational position of the array as the array is moved laterally. As another example, a trigonometric calculation may be used to determine appropriate angle(s) based upon a known distance that the array has departed from the central axis of the planting column and, in this manner, to allow independent motors/actuators to control the rotation and lateral position of the illuminator array.

In some cases, the sensor data generated by the sensors may be used to track and/or monitor the planting, pruning, harvesting, cleaning, and insertion or removal of the seed cartridges, and any other component, life stage, maintenance, or consumable associated with the environment and system. The sensor data (e.g., image data and the like) may also be used to assist or guide the user experience of farming with the system discussed herein. This experience may include an onboard touch glass interface, mobile application, audible commands, or any other type of machine to human interface. As an illustrative example, if a user plants a basil plant in the top ring section or row of the planting column, the basil may, as a tall growing plant, impact the top of the growing enclosure. In this example, if the system detects with the overhead sensor (or other sensors) data that the basil seed cartridge has been placed outside of a defined recommended planting region with respect to the plating column, the system may notify the user via the mobile application. The notification may include planting instructions to the operator to relocate the basil seed cartridge to another lower receptacle within a recommended region. In this manner, the system may include many different recommended regions associated with the planting towers. Each of the recommended regions may correspond to a different type or species of plant.

In some cases, the user interface may also be utilized by the operator to set various growth conditions for individual plants, such as exposure length, spectrums, rotational speed, and the like. The operator may also utilize the user interface to insert additional information about one or more seed cartridges inserted into the system (such as type, species, and the like). In some cases, the operator may utilize the user interface to add additional plant types, species, and settings associated therewith when new plants are introduced to the system. In some specific examples, the user interface may be utilized by the operator to control the robotic arm or system for planting and harvesting. For example, the operator may be able to select receptacles for planting and/or plants for harvesting based on the output (such as health, life-stage, or the like) provided by the system to the operator via the user interface. In some cases, the user interface may be utilized by the end customer to select plant types to be harvested and make a payment transaction with cash, credit card, digital payment systems, cryptocurrency, etc.

In some examples, the robotic system may include an electromagnetic component or a magnetic component that may be used to harvest and plant seed cartridges. For example, the seed cartridges may include a magnetic element that may be engaged, releasably coupled to, picked up by the magnetic component or an activation of the electromagnetic component of the robotic system.

In some cases, the system may also include a supply access area in which the operator or maintenance robot may access to change water, air filters, nutrient supplies and the like. In some cases, the supply access area may be accessible by an external door on the system that does not directly access the indoor environment. Accordingly, the supply access area may allow for replenishing of the system without exposing the plants to outside environmental conditions.

As one illustrative example, the indoor farming environment and system may determine an amount of light that is appropriate for a particular plant by determining from the sensor data an amount of reflection associated with, for instance, the leaves of a plant within one or more wavelengths (such as the infrared spectrum). The indoor farming environment and system may then adjust the amount, spectrum, and intensity of the light such that the leaves are absorbing within a threshold amount of 100% of the light being provided by the plant column rotation control. In this manner, the plant does not receive excess light and the indoor farming environment and system reduces overall power consumption when compared with conventional indoor farming techniques.

In some implementations, the indoor farming environment and system may also be configured to provide data, analytics, and notifications/alerts/messages to the operator or user of the indoor farming environment and system, such as via the user interface or a remote mobile application. For example, the indoor farming environment and system may analyze the captured sensor data with respect to each individual plant to determine a life stage and health associated therewith. In some cases, the indoor farming environment and system may provide a progress report, such as a growth scorecard, on a periodic basis (e.g., daily, weekly, monthly, etc.) that may be presented to the operator via the user interface, a user device, and/or, for instance, an associated application hosted by the user device and associated with the indoor farming environment and system. In some instances, the periodic basis may be defined by the operator, determined based on the type and species of plants within the enclosure, an age or life stage of the plants within the enclosure, a number of plants within the enclosure, and/or a combination thereof.

In other examples, the notification, alert, or message may also include a three-dimensional model of the indoor farming environment and system including individual planting towers and each individual plant within the indoor farming environment and system. In some cases, the three-dimensional model may accurately represent the location, size, shape, and current status of the individual plants, such as at a given time. In these cases, the operator may be able to both view the model from a 360 degree view via a user interface, such as on the user device, but also to view the model over time (such as via a time-lapse or adjustable time scale). In some specific examples, the indoor farming environment and system may record a three-dimensional model per a predetermined number of rotations of the planting column (e.g., 1, 3, 5, 10, and the like) and/or at predetermined period of time (such as every 10 minutes, every hour, every day, every week and the like). In some cases, the three-dimensional model may include multiple views (such as heatmaps) that may represent statuses of the plants, such as health, maturity, exposure time, exposure wavelengths, exposure intensity, and the like). In this manner, the user may quickly view the progress, status, and changes to the plants within the indoor farming environment and system.

In some instances, the indoor farming environment and system may also determine if there are any concerns or issues with the health and wellbeing of a plant. For example, if the indoor farming environment and system detects wilting, unusual reflections, reduced absorption, drooping and the like associated with the plant, the system may generate a notification or alert so that the user may inspect or intervene in the health of the plant. For instance, if a plant has become sick or harmful insects were introduced, the operator may remove the plant and/or the entire planting column to reduce long term damage to the overall crop output of the indoor farming environment and system.

In some implementations, the indoor farming environment and system may also provide a harvest alert or message to the operator for each individual plant. For instance, the indoor farming environment and system may determine based on the sensor data that a plant has reached between 90 and 95 percent of its maximum growth and should be harvested to improve overall yields of the indoor farming environment and system and to optimize taste (e.g., prevent bitterness that may occur when the plant starts to decay or stress). In some instances, the harvest thresholds (e.g., size, life stage, nitrogen index or metric, growth potential, taste, and the like) may be selected by the indoor farming environment and system based at least in part on an operator input, such as the type of preparation (e.g., salad, cooked, dried, and the like). For instance, earlier harvesting of plants may improve taste when the plant is eaten raw while later harvesting may increase yields, which may be preferred when the plant is being cooked.

In some specific examples, the indoor farming environment and system may determine from the sensor data an estimated yield of the harvest for the operator. The estimated yields may include a range and/or different yield amounts based on usage and/or harvest times. In some cases, the estimated yields may include data associated with different amounts based on the taste preferences of the user (such as higher yields for longer growth periods but increased bitterness in greens and the like). A chatbot may market the types, amounts, and estimated harvest dates to a list of potential buyers for marketing automation.

In one specific example, the indoor farming environment and system may also use machine learned, such as a neural network and/or deep learning models to perform object detection and classification on the plants. For instance, one or more neural networks may generate any number of learned inferences or heads. In some cases, the neural network may be a trained network architecture that is end-to-end. In one example, the machine learned models may include segmenting and/or classifying extracted deep convolutional features of the sensor data into semantic data (e.g., rigidity, light absorption, color, health, life stage, etc.). In some cases, appropriate truth outputs of the model in the form semantic per-pixel classifications (e.g., foliage, stem, fruit, vegetable, bug, decay, etc.).

In some examples, a cloud-based system may be in communication with the indoor farming environment and system and may be configured to receive and aggregate data associated with multiple indoor farming environments and systems. In some cases, the cloud-based system may process the data associated with the plants received from each of the multiple indoor farming environments and systems in order to determine adjustments to intrinsic parameters of the various sensors and systems of the enclosure. For example, the cloud-based system may apply one or more machine learned models, as discussed above and below, to determine parameters associated with the sensor that may be adjusted in future models or units of the enclosure. For example, the cloud-based system may input the captured data into a machine learned model and the model may output sensor settings for a per plant individual setting. The cloud-based system may also output settings or adjustable characteristics (such as lighting parameters, humidity or moisture parameters, dynamic sensor settings, and the like) which may be downloaded or applied to one or more of the indoor farming environments and systems.

As described herein, an exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine learning, which can refer to a broad class of such algorithms in which an output is generated based on learned parameters.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing technique and/or a combination thereof.

In some cases, the indoor farming environment and system may be equipped with UV illuminators that may be used to clean or sanitize the interior of the environment. For example, the indoor farming environment and system may detect the presence of unsanitary surfaces (e.g., mold, algae, dust, or the like) or the presence of pests within the sensor data. The system may then activate the UV illuminators at an exposure length and wavelength to kill the mold or algae or otherwise clean the interior. In some cases, the cleaning may occur between plantings, such as when the plants are fully harvested, and the system is empty. In some cases, the cleaning cycle may also include chemical treatments to reduce or remove mold, algae, pathogens, pests, or the like. In one example, the system may be equipped with a spraying system with one or more spray nozzles that may apply a chemical treatment or nutrient treatments. In some examples, if one or more planting towers are detected to have a nutrient deficiency, the spraying system may increase the duty cycle of spraying nutrients or water to increase the amount of nutrients released by slow release fertilizer contained within the seed cartridges and, thereby, improve growth of the plants. In some cases, the spraying system may include individual pump actuators or regulating valves per tower. As another example, an electrified component may be placed in proximity to the illuminators (such a illuminators outputting spectra of light designed or known to attract pests), such that as the pests approach the illuminators they are zapped or otherwise electrified and thereby eradicated.

In some cases, the irrigation control system can automatically adjust the spray cycles of each plant tower to optimize the growth quality, save energy, and maximize resource use efficiency. In a specific example, some plants may require more nutrient input and frequent spay cycles during a vegetative growth period. As another example, the indoor farming environment and system may use solar and/or wind power and may need to save energy during periods of time by reducing the spray cycles. The irrigation system can redirect the flow and direction of water, nutrients, and chemicals to any of the plant towers for growing, cleaning, or drying. In another specific example, certain types of crops may need to be dried out before harvest and the environmental and irrigation systems can specifically raise the temperature, lower humidity, increase air flow, and stop the flow of water through the spray nozzles for a drying cycle.

In some cases, the indoor farm system may be configured with at least one reservoir to manage water quality, nutrients, and chemicals. In a specific example, an indoor farm system will need to schedule times for a group of towers to be cleaned while other towers continue growing to allow for a continuous output of plants. This may require multiple reservoirs to allow for continuous cleaning of a specific number of towers while the remaining towers are used for growing. Three reservoirs may be preferred by some farmers to grow, clean, and maintain the systems. In some cases, each tower system may have its own independent reservoir isolated from the other tower systems.

In some specific examples, the indoor farming environment and system may also be equipped with lasers or heat sources, in addition to use of the UV illuminators, that may be used for targeted termination. For example, the system may utilize the sensor data to detect the presence of pests, eggs, larvae, insects, fungal/bacterial spots, and the like at specific regions, areas, or parts of a plant (such as a leaf). The system may then utilize the lasers, heat sources, and/or UV illuminators to target and eradicate the pests, eggs, larvae, insects, fungal/bacterial spots, and the like at the specific region, area, or plant part. In this manner, the collateral damage to the plants may be reduced while saving the remainder of the harvest. In one specific example, a laser may be used to blast or shoot down a flying insect (such as a mosquito) within the indoor environment.

In some implementations, the indoor farming environment and system may utilize computer vision techniques, three-dimensional special processing, and one or more machine learned models to segment and classify image data of the interior of the environment and detect and classify different types of pests, insects, fungus, mold, eggs, larvae, bacteria, and the like. The system may then tailor the irradiation and treatments to the specifically identified pest. In some cases, the indoor farming environment and system may also identify between beneficial and harmful insects based on the segmented and classified image data. In these cases, the system may allow the beneficial insects (e.g., bees) to survive/thrive within the indoor farming environment while providing treatment for the harmful insects (e.g., locusts). In one example, the beneficial insects may be herded to specific plants, such as those that would benefit from pollination, using the systems (e.g., lasers, illuminators, heat sources, airflow or ventilation systems, and the like) of the indoor farming environment.

As one specific example, the indoor farming environment and system may include or be coupled to a manifold that comprises a beehive or other useful home for pollinators. For example, the manifold may be accessible by the operator from the exterior of the indoor farming environment and system to harvest any honey or other products produced by the pollinators. The manifold may also include a passage or opening that may allow the pollinators to travel back and forth to the interior of the indoor farming environment. In some cases, the system may close the passage to the interior of the indoor farming environment when the exterior access is open for harvesting the honey or other products.

In some implementations, the indoor farming environment and system may utilize computer vision techniques, three-dimensional special processing, and one or more machine learned models to segment and classify image data of the interior of the environment and detect and classify plants as well as portions of plants. For example, the system may detect and classify flowers of fruit producing plants and prune the flowers using robotic systems to increase the output of fruit. As another example, the system may identify male-sex plants that may be detrimental to the productivity of female-sex plants. In this example, the system may identify the male-sex plant and cause the system to prune, eradicate, or harvest it, such as via the robotic system, lasers, heat sources, and the like.

In one specific example, the system may utilize thermal sensor data and/or one or more machine learned models to detect and diagnose issues with illuminators, heating and cooling systems, as well as other equipment. In some cases, the thermal data may be usable to detect regions experiencing poor or low airflow, such as by overgrowth or errant-growth of one or more plants, and to select plants for harvesting prior to damage, such as tip burn.

In some cases, the indoor farming environment and system may also be configured to utilize the sensor data to determine equipment failures, blockages (such as in the nutrient and/or water reservoirs, air vents, or the like), and the like. In some cases, the robotic system may be configured to access the supply access area from the interior and to change the air vents, nutrient and/or water reservoirs, or perform repairs using materials inserted by the operator. In some cases, the robotic system may be operator controlled via the user interface to effectuate any repairs in a fully or partially machine supervised manner.

The indoor farming environment and system may also be equipped with an air-intake system or manifold to refresh and supply air to the interior environment. In some cases, the air-intake system may also control humidity, gas composition and percentages (e.g., CO₂, O₂, VOC, NO, N₂O and the like). In some examples, the air intake manifold may couple or connect to a high carbon-dioxide source (such as a power generation station, fermentation process, commercial or residential building with high human occupancy or any industrial process that emits high amounts of carbon-dioxide) to increase the amount of carbon-dioxide within the interior of the environment and, thereby, the efficiency of photosynthesis. In some cases, the system may also include sensors for detecting and measuring concentrations and amounts of carbon dioxide entering into the interior, and within the interior. For instance, the carbon dioxide data may be used for reporting, claiming, and capitalizing on governmental environmental credits. The system may also include an air outlet system or manifolds to deposit or output from the interior environment highly oxygenated air. In some cases, the highly oxygenated air may be output into a residential or commercial building to improve indoor air quality. Similar to the sensors for detecting and measuring concentrations and amounts of carbon dioxide, the system may include sensors for measuring concentrations and amounts of oxygen exiting the environment.

The system may also include a water control system that monitors and controls intake and output of water. For example, the water control system may include water treatment components (e.g., RO, filter, UVC, and the like), humidity generators and/or condensers, temperature controls, and the like.

The indoor farming environment and system may also include a heat displacement system. For example, the illuminators may generate excessive heat that in conventional indoor farming reduces germination rates. The indoor farming environment and system, discussed herein, may include a heat displacement system to control the temperature and output heat from the interior of the environment. For example, the heat displacement system may include a heat sink and/or duct (such as a ducted aluminum extrusion or an outward fin aluminum extrusion), in some cases coupled to the illuminator arrays, to spread and dissipate the heat within the indoor farming environment. In some cases, the heat sink/duct may extend to an exterior of the indoor farming environment and may be configured such that raising heat within the environment may be leveraged into the air duct/heat sink and cooled via exterior air or fluid. In other cases, the rising heat may be output from the interior into the exterior of the environment. The duct system may also include fans to force or displace the hot air. The heat displacement system may also include holes or gaps within the illuminator arrays that have an increasing size the higher up on the array that may cause an air pulling venturi effect to remove hotter air from the upper regions of the environment. The heat displacement system may also include fans, such as in the lower corners of the planting towers, to create an evaporative cooling effect of airflow over the water reservoir and/or the nutrient reservoir positioned along the bottom of the indoor farming environment. In some cases, the fans may be positioned such that they are blowing upwards to displace the heat generated by the illuminators. Additional fans may also be placed or positioned in the upper corners of the planting towers to pull cooler air upwards. In some cases, the air duct or the heat displacement system may incorporate some aspect of a tesla valve to force the flow of air upwards with rising force of heat.

In some cases, the indoor farming environment and system may have a transparent roof and/or side panels that allow entry of natural light to enhance the photosynthetic efficiency of the plants and warm the internal environment in cooler climates. In some cases, the exterior surfaces of the indoor farming environment and system may be formed from materials that filter/refract spectra of light to allow only spectra that are within more beneficial wavelengths for photosynthesis. The indoor farming environment and system may also include solar tubes with sunlight collection domes external to the indoor farming environment. The solar tubes may redirect sunlight to the top and sides of the planting towers.

The indoor farming environment and system may also include one or more observation windows to provide the operator or consumers with a visual indicator of the sourcing of produce on display for supply chain transparency.

In some cases, the indoor farming environment and system may include various power sources. For example, the indoor farming environment and system may include a series of solar panels, generators, nuclear reactors, and/or wind turbines. For instance, the indoor farming environment and system may include a helix upright vertical wind turbine that may directly create rotational force to rotate the planting towers. The indoor farming environment and system may also include rainwater collection receptacles to collect water to be used in hydroponic cultivation, discussed herein. For example, an arched transparent roof may be used to direct water to gutters for collection and provide longer daylight exposure to the plants. In some cases, the indoor farming environment and system may be used in drier climates. In these climates, the system may utilize evaporative cooling air conditioners to cool the incoming air or a heat exchanger to maintain cooler or desired growing environments. As another example, the indoor farming environment and system may be coupled to or otherwise connected to a geothermal heating/cooling system that maintains a desired temperature within the interior environment.

In some examples, the indoor farming environment and system may be portable or moveable. In these examples, the indoor farming environment and system may include wheels that are lockable when in use. In this example, water and/or electrical conduits may be protected by a durable speed bump system to allow passage of vehicles over the conduit without requiring foundational concrete modifications that may require municipal permit approvals (such as when the system is utilized in a restaurant parking lot). The portable indoor farming environment and system may also be equipped with forklift mounting positions, mounting hooks on the external frame (for securing or crane coupling), or the like. In some cases, the indoor farming system may be placed on a trailer or platform that includes a dedicated water supply tank, drain tank, and battery system for power.

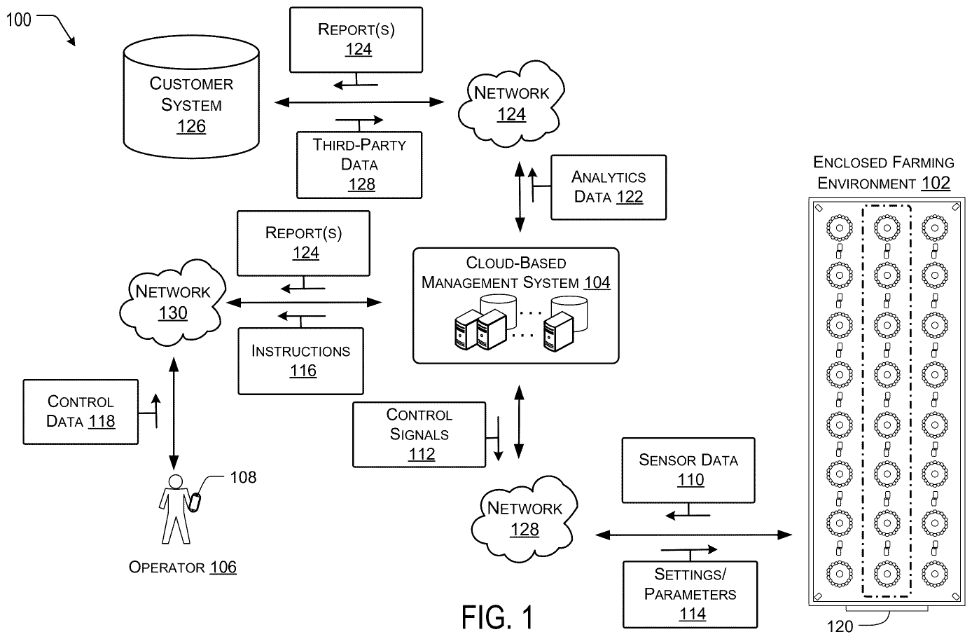

FIG. 1 is an example pictorial diagram of a system 100 associated with an indoor farming environment according to some implementations. As discussed above, an enclosed farming environment 102 is in communication with a cloud-based system 104 to allow for cultivation of a large variety of produce with reduced labor skills compared with conventional indoor farming in a highly compact or dense manner is discussed. For example, the enclosed farming environment 102 may be configured to provide an enclosed area for indoor cultivation of produce. The enclosed farming environment 102 may, in some implementations, provide an isolated enclosure that is configured to provide stable and controlled environmental conditions, physically separated from the conditions within a surrounding outdoor environment.

In some examples, the enclosed farming environment 102 may be configured with multiple planting towers or columns configured to receive one or more seed cartridges via one or more receptacles, receiving slots, or cavities, as discussed in more detail below. For instance, the environment 102 may include between 10 and 40 planting towers either in a fixed or rotatable (movable) configuration. As one example, the enclosed farming environment 102 may include three rows with each row including eight planting towers. In some cases, the planting towers may be rotatable three-hundred and sixty degrees within the enclosure and about a base, or any other limited rotation. In some instances, as the planting towers rotates, each individual planting receptacle of each individual planting tower may be assigned a unique identifier, such that the system is able to monitor and track each seed cartridge and resulting plant based on a determined location within the planting towers and the enclosed farming environment 102. The planting towers may also be coupled to a water reservoir that is configured to provide water to the seed cartridges on, for example, an individualized basis.

In some cases, the enclosed farming environment 102 may include an access panel or area that allows for an operator, such as operator 106, to access at least a portion of one of the planting towers for the insertion of seed cartridges into receptacles and/or the harvesting of plants upon maturation. For example, the planting towers may be mounted on a movable track, such that the planting towers may move (positionally relative to each other and the environment) as well as rotate in place as desired for providing customized or individualized nutritional requirements (such as lighting). In this manner, the operator 106 may utilize the access area to plant and harvest produce as desired. In some cases, the access area may be a door or panel that allows for access to an adjacent planting tower, while in other examples, the access area of the enclosed farming environment 102 may be an aisle between rows and/or columns of planting towers. In still other examples, the access area may include a region that allows for access of multiple planting towers but less than full access to all planting towers (e.g., the operator may access a subset of the planting towers). In some cases, the access area of the enclosed farming environment 102 may include or be adjacent to an isolation foyer or area that includes an entry door between the indoor environment and the exterior and a flexible door or strip curtain may be used behind the entry door to limit outside environment exposure.

In some examples, the indoor farming environment 102 may be configured for self or robotic harvesting and planting. In these examples, the indoor farming environment 102 may be closed in such a manner that the operator 106 may be unable to access the internal systems during normal use or the operator 106 may be a remote operator 106 in communication with the cloud-based management system 104 via a user device 108. In this manner, space, region, or area of the enclosed farming environment 102 used for the access area may be converted into areas designed to grow additional plants, thereby increasing yields and the system may prevent unwanted pests, pathogens, and air entry into the indoor environment. In these examples, a robotic arm (such as a multi-axis robotic arm) or other harvesting system may be configured to utilize computer vision to receive, grasp, and insert seed cartridges into designated planting receptacles. In some cases, the robotic system may be associated with a track that may be positioned, for instance, along a top surface of the interior of the environment, to allow the robotic system to move within the enclosed farming environment 102.

The robotic arm or other system may be also configured to utilize computer vision to identify, harvest, prune, pollinate, clean, and otherwise remove plants from the planting tower and deliver the plants to a collection area, where the plants may be removed from the enclosed farming environment 102. For example, the enclosed farming environment 102 may operate as a vending machine that receives seed cartridges and outputs plants. In some cases, the input area and the collection area may include multiple doors that may open and close to prevent outside air, dust, pests, pathogens in the like from entering the enclosed farming environment 102. In some cases, an access chamber may open a first door to receive a seed cartridge, close the first door, remove (e.g., such as via a vacuum) or otherwise treat (introduce pesticides or the like) or clean the chamber via a water or other spray, and open a second door (associated with the indoor environment) to allow the robotic system to plant the seed cartridge. Likewise, a similar process may be performed in reverse when harvesting plants.

In various implementations, the enclosed farming environment 102 may include sensors (such as humidity sensors, temperature sensors, thermal, and the like as well as image devices including infrared sensors, red-green-blue sensors, ultraviolet light (UV) sensors, radar, lidar, and the like) to track and/or monitor each individual plant or receptacle within the enclosed farming environment 102. The enclosed farming environment 102 may also be equipped with various light sources or illuminators (e.g., infrared light illuminators, visible light illuminators, UV light illuminators, and the like), water systems, environmental control systems (e.g., heating systems, cooling systems, humidity systems, and the like), and nutrient providing systems. In this manner, unlike conventional indoor farming systems that provide uniform lighting, temperature, water, and other environmental conditions, the enclosed farming environment 102, discussed herein, may provide active monitoring and adaptive environmental conditions for individual plants based on the health, stage of growth, type or species of plants, and the like.

In the various examples, discussed herein, the enclosed farming environment 102 may be configured to monitor individual plant(s) within the indoor farming environment 102 and to provide tailored growing conditions, such as custom lighting (e.g., length of exposure via tower rotation, tilt, and/or angular positioning/orientation, focal length, temperature, specific wavelengths, intensity, amount, and the like) for each plant or receptacle. In some cases, the individual growing conditions may be based on a detected or determined health, size, and/or stage of growth or reproduction of an individual plant within the receptacle in addition to the type or species of the individual plants. Further, the indoor farming environment 102 may be used to induce post-harvesting dying conditions at the end of the plants' growth cycle.

In these examples, the enclosed farming environment 102 may generate sensor data 110 associated with one or more plants currently being cultivated in the enclosed farming environment 102 and provide the sensor data 110 to the cloud-based management system 104. The management system 104 may then determine health, size, and/or stage of growth or reproduction of an individual plant within the receptacle in addition to the type or species of the individual plants. For example, the management system 104 may input the sensor data 110 into one or more machine learned models or networks that are trained using sensor data (such as image data) of various different types of plants (such as crops typically cultivated for human or animal consumption) in various stages of growth (e.g., life stages), health conditions (e.g., healthy, diseased, pest infected, and the like), representing plant growth over time (e.g., at multiple life stages) under different environmental conditions (e.g., lighting, water access, nutritional access, temperature, humidity, and the like), and the like. In some cases, the training data may include descriptors associated with plant identities, health status, and the like to provide assistance in training the machine learning models and networks.

Once identified, the management system 104 may generate control signals 112 and setting and parameters 114 for controlling the systems and equipment (such as the robotic harvester system, the lighting system, water system, nutrient supplementation system, temperature system, other environmental systems, and the like) of the enclosed farming environment 102. For example, the settings and parameters 114 may include settings for the exposure, lighting spectrum, CO₂ levels, nutritional additives to the water supply, and the like to each plant being cultivated within the enclosed farming environment 102. The control signals 112 may include instructions for the robotic harvester, pest extermination system, or the like to take action with regards to the environment 102 and/or individual plants within the environment 102, such as harvesting a specific plant at a specific tower/slot location.

In some cases, the cloud-based management system 104 may also provide instructions 116 to the operator 106 via the user device 108 and associated with the enclosed farming environment 102. For example, the system 104 may determine that specific plants within the enclosed farming environment 102 may require planting, pruning, harvesting, cleaning, removal, or the like that may not be performed by the robotic systems of the enclosed farming environment 102. For example, if a plant needs to be relocated within the enclosed farming environment 102, the management system 104 may detect the plant was placed incorrectly via the sensor data 110 and send instructions 116 including the location of the erroneously placed plant and a desired replanting location within the enclosed farming environment 102. The operator 106 may then enter the enclosed farming environment 102 and execute the relocation operation by hand. In other cases, the instructions 116 may include planting, harvesting, cleaning, system maintenance operations, and the like that should be performed by the operator 106.

In some cases, the enclosed farming environment 102 may also include on-board control system and user interface 120, such as via a control panel or touch enabled display, on the exterior of the environment 102. In some cases, the cloud-based management system 104 may experience communication disruption with the enclosed farming environment 102 and/or robotic systems of the enclosed farming environment 102 may be damaged. In these cases, the cloud-based management system 104 may provide control data 118 to the operator 106 via the user device 108 (e.g., an application hosted on the user device 108). The control data 118 may include settings for the exposure, lighting spectrum, CO₂ levels, nutritional additives to the water supply, and the like to each plant being cultivated within the enclosed farming environment 102 and to be input or set by the operator 106.

In some implementations, the indoor farming environment 102 and the management system 104 may also be configured to provide analytic data 122 and reports 124, such as notifications/alerts/messages, to the operator 106 and/or to third-party customer systems 126. For example, the system 104 may analyze the captured sensor data 110 with respect to each individual plant and each environment 102 to determine analytic data 122 associated with each plant and/or the collection of plants within each environment 102. In some cases, the management system 104 may provide a report 124, such as a progress report, a growth scorecard, or the like, on a periodic basis (e.g., daily, weekly, monthly, etc.) that may be presented to the operator 106 and/or third-party customer system 126. For example, the report 124 and/or analytics data 122 may include harvest or yield estimates, health data, delivery estimates, estimated purchase prices, and the like.

In some cases, the system 104 may receive from the third-party customer system 126 third party data 128, such as responsive to the reports 124 and/or analytics data 122. For example, the third-party data 128 may include purchase orders for specific plants or crops, delivery locations and times, requests to initiate cultivation of new plants or crops (e.g., new species or additional units of existing species), identity of shipping agents, request to inspect products, or the like.

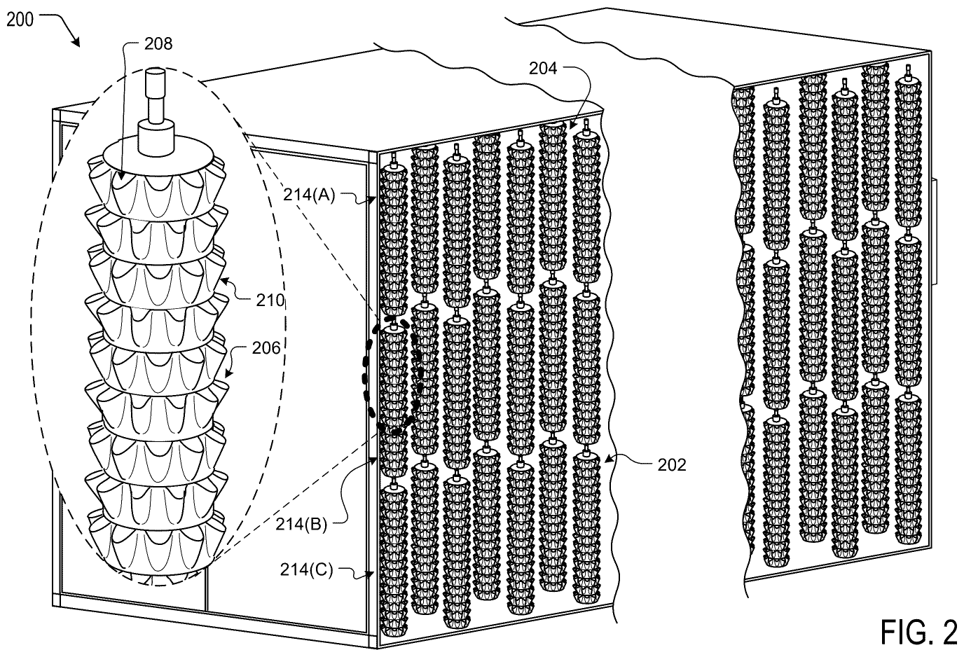

FIG. 2 is an example pictorial diagram of a portion of an indoor farming environment 200 according to some implementations. In the current example, the exterior wall is not shown, such that a first row of planting towers 202 and a second row of planting towers 204 of a plurality of rows of planting towers is visible. In the current example, the rows 202 and 204 of the indoor farming environment 200 are aligned or each column is adjacent to the equivalent column in the neighboring row. In other examples, the columns of each row 202 and 204 may be offset from each other to provide ease of access.

As discussed above, each of the planting towers may be configured to receive one or more seed cartridges via one or more receptacles, receiving slots, or cavities, generally indicated by 206. For example, each of the planting towers may comprise a plurality of receptacles 206 configured to receive individual seed cartridges or pods that may be placed via a robotic mechanism or system and/or by an operator. The planting receptacles 206 may be arranged both in vertical columns 208 and horizontal rows 210 about each of the planting towers. For instance, in one specific example, the planting tower may include 10 columns and 21 rows 210 of planting receptacles 206 per planting tower or per planting tower segment 212 (e.g., each tower may include multiple segments, such as segment 214 in the illustrated example). In some cases, the planting receptacles 206 may be staggered between the columns and adjacent columns, such that each column has one planting slot for every other row, as illustrated. In these cases, staggering the planting receptacles 206 allows the system to be able to monitor conditions of each individual plant and provide individualized nutrition (lighting conditions, water supply, and nutrients) as well as allowing each individual plant sufficient room to grow. In some cases, the columns and rows may be staggered or spaced differently to allow for improved plant growth, human access, and robotic access. As one alternative example, each planting tower may include smaller rings (e.g., five receptacle rings, seven receptacle rings, or the like). In some examples, the number of columns, rows, rings, or receptacles per ring may vary based at least in part on a target crop(s) to be cultivated.

In some examples, seed cartridges may be specifically designed to mate and/or otherwise be received within a cavity defined by each the receptacle 206 of the planting towers. The seed cartridges may be a self-contained apparatus having an exterior structure of one or more surfaces or walls that contain one or more seeds suspended in one or more layers of substrate or growing medium. For example, in some cases, the substrate or medium may include a first or bottom layer of fertilizer (such as slow release fertilizer prills). There may be a second layer over the fertilizer that is composed of an open cell polyurethane foam (e.g., a compostable polyurethane foam). In some cases, the second layer may be included to separate the seeds from the fertilizer prills, wick water upwards to seeds, provide a foundation for root growth, and drain water downwards, so the cartridge does not become oversaturated and generate undesirable anaerobic/aerobic microbial growth. Additionally, the second layer may prevent root burn and/or damage from the higher concentrations of nitrates in the fertilizer prills. In some instances, the second layer may be a single solid media to prevent the seeds from becoming translocated throughout the substrate during transport and, thereby, not growing out top of the cartridge as desired. As an alternative example, the second layer may be a PLA fiber growing media. In some instances, the media of the second layer is dark colored or black so as to not reflect light and thereby prevent algae growth.

In some cases, the seeds may be positioned as a third layer, above the second layer. The seeds may be suspended in a foam or other solid and compostable media plug. In some cases, the plug may be thermally and/or mechanically formed inserts having a size to match the size of the seeds. A fourth layer may be positioned above the seed layer and/or third layer. The fourth layer may include a loose growing media placed over the seeds. The growing media may be loose for the seedlings to grow through as the foliage cannot pass through a solid or tightly packed media. In some cases, the loose growing media may include paper fiber. The paper fiber may be configured to become saturated and retain moisture to ensure good germination rates of the seeds.

In some examples, the seed cartridge may include a removable top surface, a bottom surface parallel to the top surface, and a side wall or surface. For example, the top surface may be peelable or otherwise removable such that during transport and handling the top surface may act as a lid to maintain the substrate, seeds, and/or other medium within the cartridge. The top surface may then include a tap or extended portion that may be gripped, by, for instance, a user inserting the cartridge into the planting tower, and then separated, peeled, or otherwise removed from the cartridge to allow the plant to sprout from and extend upward from the substrate within the cartridge. The lid may be partially sealed permanently and partially sealed temporarily, so that the lid (with the plant identifier) remains partially attached to the seed pod cup even if a significant portion of the lid was opened to allow for plant growth.

In some cases, the tap or extended portion may include at least two flat sides or portions, such that the seed cartridge does not roll, experience longitudinal rotation, or otherwise slide on flat surfaces, such a table or counter, or during transport and shipping. For instance, in one example, the tab may be formed in a substantially triangular shape in which the apex of the triangle is extended from the base which couples to the exterior side surface.

In some examples, the side surface may be substantially coned shaped to provide a larger top surface when compared with the bottom surface. However, it should be understood that the exterior surface of the seed cartridge may take various forms and/or shapes, such as substantially rectangular prisms, substantially triangular prisms, substantially pyramidal, and the like.

The seed cartridge may include one or more openings, holes, or slits along the exterior side surface to allow water to be delivered from the planting tower to the seeds and/or substrate within the seed cartridges. The slits may be arranged in columns along the side surface and the columns may extend substantially the entire width of the exterior side surface, such that the slits are located along substantially the entire width of the cartridge. In some examples, the size of the slits may vary in size or length (as measured from the top surface to the bottom surface of the cartridge) with respect to each other. For instance, lower slits may be both longer relative to higher slits as well as closer together (e.g., the distance between the slits is reduced). In some cases, the columns of slits may also become closer to each other (e.g., the horizontal or width wise gaps between the slits may be reduced) as the slits approach the bottom surface (e.g., slits proximate to the bottom surface are closer horizontally and vertically to other slits than slits proximate to the top surface). In some examples, the slits may continue along the bottom surface of the seed cartridge. For example, the lowest slit in each column may partially extend into the bottom surface of the seed cartridge to provide improved drainage during use.

In this manner, the slits concentrically approach near, or at the center of the cartridge as the slits approach the bottom surface of the cartridge. The concentrically designed slits improve upon other traditional seed delivery containers by comparatively directing root growth downwards and increasing the plants and seeds access to water and nutrients contained in the lower sections of the cartridge. Additionally, the concentrically designed slits of the seed cartridge provide for easier manufacturing and, in particular, injection molding of the cartridges. In some examples, the slits may be configured with rounded corners and the corners may be equipped with filets to add structural integrity to the carriage during use and to assist with the flow of the liquid polymer or other material that is injected into a mold during manufacturing.

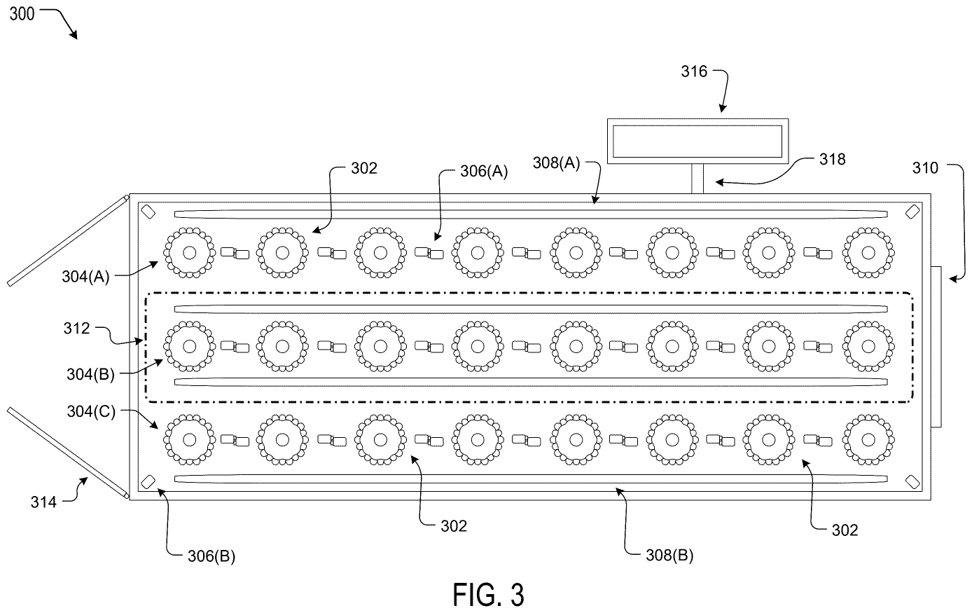

FIG. 3 is an example pictorial top down diagram of an indoor farming environment 300 according to some implementations. The planting towers, generally indicated by 302, are arranged in rows, generally indicated by 304. In the current example, the indoor farming environment 300 includes three rows of planting towers 302, however, it should be understood that any number of planting towers may be implemented within the indoor farming environment 300, such as 4 rows, 5 rows, 6, rows, 10 rows, 15 rows, and the like.

In some implementations, the indoor farming environment 300 may include between 10 and 40 planting towers. In other implementations, the indoor farming environment 300 may include between 20 and 25 planting towers. In one specific example, the indoor farming environment 200 may include 24 planting towers (e.g., 5,040 receptacles 206 or plants per indoor farming environment 300), such as in the illustrated example. For instance, as illustrated, the indoor farming environment 300 may include three rows 304(A)-(C) with each row including eight planting towers 302. In other implementations, the indoor farming environment 300 may include between 30 and 35 planting towers. For instance, the indoor farming environment 300 may include 32 planting towers, e.g., the system may include four rows with each row including eight planting towers (e.g., 6,720 receptacles or plants per system).

In some cases, each planting tower 302 may be rotatable three-hundred and sixty degrees within the indoor farming environment 300 and about a base, or any other limited rotation. For example, a drive motor may be configured to mechanically or magnetically rotate each planting tower 302 within the indoor farming environment 300 based on one or more control signals from a monitoring and control system. In some instances, as each planting towers 302 rotates, each individual planting receptacle of each individual planting tower 302 may be assigned a unique identifier, such that the control systems of the indoor farming environment 300 and/or an associated cloud-based system, such as system 104 of FIG. 1, may be able to monitor and track each seed cartridge and resulting plant based on a determined location within the planting towers 302 and the indoor farming environment 300. The planting towers 302 may also be coupled to a water reservoir that is configured to provide water to the seed cartridges on, for example, an individualized basis.

In various implementations, the indoor farming environment 300 may include sensors, generally indicated by 306, (such as humidity sensors, temperature sensors, thermal, and the like as well as image devices including infrared sensors, red-green-blue sensors, ultraviolet light (UV) sensors, and the like) to track and/or monitor each individual plant or receptacle within the indoor farming environment 300. The sensor 306 may also include various light sources or illuminators (e.g., infrared light illuminators, visible light illuminators, UV light illuminators, and the like).

The indoor farming environment 300 may also include water systems, environmental control systems (e.g., heating systems, cooling systems, humidity systems, and the like), generally indicated by 308, and nutrient providing systems. For example, in some specific examples, the indoor farming environment 300 may include air ducts 308 that include heat sinks and UV illuminators to both extract heat from the interior environment of the indoor farming environment 300 and to clean air (such as to remove or kill pathogens) within the indoor farming environment 300.

For instance, in some specific implementations, the indoor farming environment 300 may be configured to monitor individual plant(s) within the indoor farming environment and to provide tailored growing conditions, such as custom lighting (e.g., length of exposure via tower rotation, tilt, and/or angular positioning/orientation, focal length, temperature, specific wavelengths, intensity, amount, and the like) for each plant or receptacle. In some cases, the individual growing conditions may be based on a detected or determined health, size, and/or stage of growth or reproduction of an individual plant within the receptacle in addition to the type or species of the individual plants. Further, the indoor farming environment 300 may be used to induce post-harvesting dying conditions at the end of the plants' growth cycle.

In some implementations, a lighting and control system, such as sensors 306(A), may be configured within the indoor farming environment 300 or along a specific region of the indoor farming environment. The lighting and control systems may be configured to monitor individual plants. The lighting and control systems may capture sensor data of the individual plants and receive adjustment settings to provide specific spectrums, amounts of light, and intensities of light to each individual planting based on the corresponding plant's health, life stage, size, and type or species, as discussed herein.

In some cases, the sensor data generated by the sensors 306 may be used to track and/or monitor the planting, pruning, harvesting, cleaning, and insertion or removal of the seed cartridges, and any other component, life stage, maintenance, or consumable associated with the indoor farming environment 300. The sensor data (e.g., image data and the like) may also be used to assist or guide the user experience of farming with the indoor farming environment 300 discussed herein. This experience may include an onboard user interface 310 (e.g., a touch glass interface), mobile application, audible commands, or any other type of machine to human interface.

In some cases, the user interface 310 may also be utilized by the operator to set various growth conditions for individual plants, such as exposure length, spectrums, rotational speed, and the like. The operator may also utilize the user interface 310 to insert additional information about one or more seed cartridges inserted into the system (such as type, species, and the like). In some cases, the operator may utilize the user interface 310 to add additional plant types, species, and settings associated therewith when new plants are introduced to the system.

In some specific examples, the user interface 310 may be utilized by the operator to control the robotic system 312 for planting and harvesting. For example, the operator may be able to select receptacles at the user interface 310 for planting and/or plants for harvesting based on the output (such as health, life-stage, or the like) provided by the indoor farming environment 300 to the operator via the user interface 310. In some cases, the user interface 310 may be utilized by the end customer to select plant types to be harvested and make a payment transaction with cash, credit card, digital payment systems, cryptocurrency, and the like.

In some examples, the robotic system 312 may include an electromagnetic component or a magnetic component that may be used to harvest and plant seed cartridges. For example, the seed cartridges may include a magnetic element that may be engaged, releasably coupled to, picked up by the magnetic component or an activation of the electromagnetic component of the robotic system 312. In the current example, the robotic system 312 may be attached to a track along the ceiling or other surface of the indoor farming environment 300 such that the robotic system 312 may move within the indoor farming environment 300 and access each of the towers 302, such as for planting, harvesting, pruning, cleaning, pest eradication, or other operations.

In some cases, the indoor farming environment 300 may also include a supply access area 314 in which the operator or maintenance robot may access to change water filters, air filters, nutrient supplies and the like. In some cases, the supply access area 314 may be accessible by an external door on the indoor farming environment 300 that does not directly access the indoor environment. Accordingly, the supply access area 314 may allow for replenishing of the indoor farming environment 300 without exposing the plants to outside environmental conditions. In other cases, the supply access area 314 may allow the operator to enter the indoor farming environment 300 to perform operations on the plants.

As one illustrative example, the indoor farming environment 300 may determine an amount of light that is appropriate for a particular plant by determining from the sensor data output by the sensors 302 an amount of reflection associated with, for instance, the leaves of a plant within one or more wavelengths (such as the infrared spectrum). The indoor farming environment 300 may then adjust the amount, spectrum, and intensity of the light such that the leaves are absorbing within a threshold amount of 100% of the light being provided by the plant column rotation control. In this manner, the plant does not receive excess light and the indoor farming environment 300 reduces overall power consumption when compared with conventional indoor farming techniques.

In some cases, the indoor farming environment 300 and/or the robotic system 312 of the indoor farming environment 300 may be equipped with UV illuminators that may be used to clean or sanitize the interior of the environment. For example, the indoor farming environment 300 may detect the presence of unsanitary surfaces (e.g., mold, algae, dust, or the like) or the presence of pests within the sensor data generated by the sensors 302. The indoor farming environment 300 may then activate the UV illuminators at an exposure length and wavelength to kill the mold or algae or otherwise clean the interior. In some cases, the cleaning may occur between plantings, such as when the plants are fully harvested, and the system is empty. In some cases, the cleaning cycle may also include chemical treatments to reduce or remove mold, algae, pathogens, pests, or the like.

In one example, the indoor farming environment 300 and/or the robotic system 312 may be equipped with a spraying system with one or more spray nozzles that may apply a chemical treatment or nutrient treatments. In some examples, if one or more planting towers 302 are detected to have a nutrient deficiency, the spraying system may increase the duty cycle of spraying nutrients or water to increase the amount of nutrients released by slow release fertilizer contained within the seed cartridges and, thereby, improve growth of the plants. In some cases, the spraying system may include individual pump actuators or regulating valves per tower. As another example, an electrified component may be placed in proximity to the illuminators (such a illuminators outputting spectra of light designed or known to attract pests), such that as the pests approach the illuminators the pests are zapped or otherwise electrified and thereby eradicated.

In some cases, the irrigation control system of the indoor farming environment 300 may automatically adjust the spray cycles of each plant tower to optimize the growth quality, save energy, and maximize resource use efficiency. In a specific example, some plants may require more nutrient input and frequent spay cycles during a vegetative growth period. As another example, the indoor farming environment 300 may use solar and/or wind power and may need to save energy during periods of time by reducing the spray cycles. The irrigation system can redirect the flow and direction of water, nutrients, and chemicals to any of the plant towers for growing, cleaning, or drying. In another specific example, certain types of crops may need to be dried out before harvest and the environmental and irrigation systems can specifically raise the temperature, lower humidity, increase air flow, and stop the flow of water through the spray nozzles for a drying cycle.

In some specific examples, the indoor farming environment and system may also be equipped with lasers or heat sources, in addition to use of the UV illuminators, that may be used for targeted termination. For example, the system may utilize the sensor data to detect the presence of pests, eggs, larvae, insects, fungal/bacterial/mold spots, and the like at specific regions, areas, or parts of a plant (such as a leaf). The system may then utilize the lasers, heat sources, and/or UV illuminators to target and eradicate the pests, eggs, larvae, insects, fungal/bacterial/mold spots, and the like at the specific region, area, or plant part. In this manner, the collateral damage to the plants may be reduced while saving the remainder of the harvest. In one specific example, a laser may be used to blast or shoot down a flying insect (such as a mosquito) within the indoor environment.

In some implementations, the indoor farming environment 300 may utilize computer vision techniques, three-dimensional special processing, and one or more machine learned models to segment and classify sensor data generated by the sensor 302 and detect and classify different types of pests, insects, fungus, eggs, larvae, bacteria, and the like. The indoor farming environment 300 may then tailor the irradiation and treatments to the specifically identified pest. In some cases, the indoor farming environment 300 may also identify between beneficial and harmful insects based on the segmented and classified image data. In these cases, the system may allow the beneficial insects (e.g., bees) to survive/thrive within the indoor farming environment 300 while providing treatment for the harmful insects (e.g., locusts). In one example, the beneficial insects may be herded to specific plants, such as those that would benefit from pollination, using the systems (e.g., lasers, illuminators, heat sources, airflow or ventilation systems, and the like) of the indoor farming environment 300.

As one specific example, the indoor farming environment 300 may include or be coupled to a manifold 316 that comprises a beehive or other useful home for pollinators. For example, the manifold 316 may be accessible by the operator from the exterior of the indoor farming environment 300 to harvest any honey or other products produced by the pollinators. The manifold 316 may also include a passage or opening 318 that may allow the pollinators to travel back and forth to the interior of the indoor farming environment 300. In some cases, the indoor farming environment 300 may close the passage 318 to the interior of the indoor farming environment 300 when the excess area of the manifold 316 is open for harvesting the honey or other products.

The indoor farming environment 300 may also be equipped with an air-intake system or manifold 308 to refresh and supply air to the interior environment 300. In some cases, the air-intake system 308 may also control humidity, gas composition and percentages (e.g., CO₂, O₂, VOC, NO, N₂O and the like). In some examples, the air intake system or manifold 308 may couple or connect to a high carbon-dioxide source (such as a power generation station, fermentation process, or any industrial process that emits high amounts of carbon-dioxide) to increase the amount of carbon-dioxide within the interior of the indoor farming environment 300 and, thereby, the efficiency of photosynthesis. In some cases, the sensor system 302 may also include sensors for detecting and measuring concentrations and amounts of carbon dioxide entering into the interior, and within the interior. For instance, the carbon dioxide data may be used for reporting, claiming, and capitalizing on governmental environmental credits. The air intake system or manifold 308 may also include an air outlet system or manifolds to deposit or output from the interior environment highly oxygenated air. In some cases, the highly oxygenated air may be output into a residential or commercial building to improve indoor air quality. Similar to the sensors for detecting and measuring concentrations and amounts of carbon dioxide, the system may include sensors for measuring concentrations and amounts of oxygen exiting the indoor farming environment 300.

The indoor farming environment 300 may also include a heat displacement system such as within the air intake system or manifold 308. For example, the illuminators may generate excessive heat that in conventional indoor farming reduces germination rates. The indoor farming environment 300, discussed herein, may include a heat displacement system within the air intake system or manifold 308 to control the temperature and output heat from the interior of the indoor farming environment 300. For example, the heat displacement system may include a heat sink and/or duct (such as a ducted aluminum extrusion or an outward fin aluminum extrusion), in some cases coupled to the illuminator arrays or the indoor farming environment 300, to spread and dissipate the heat within the indoor farming environment 300.

In some cases, the heat sink/duct may extend to an exterior of the indoor farming environment 300 and may be configured such that raising heat within the environment 300 may be leveraged into the air duct/heat sink and cooled via exterior air or fluid. In other cases, the rising heat may be output from the interior into the exterior of the environment 300. The duct system may also include fans to force or displace the hot air. The heat displacement system may also include holes or gaps within the illuminator arrays that have an increasing size the higher up on the array that may cause an air pulling venturi effect to remove hotter air from the upper regions of the environment. The heat displacement system may also include fans, such as in the lower corners of the planting towers, to create an evaporative cooling effect of airflow over the water reservoir and/or the nutrient reservoir positioned along a bottom of the indoor farming environment. In some cases, the fans may be positioned such that they are blowing upwards to displace the heat generated by the illuminators. Additional fans may also be placed or positioned in the upper corners of the planting towers to pull cooler air upwards.

In some specific example, the manifold 308 may include an array of illuminators (such as LEDs) and heat sinks (such as an aluminum or zinc heat sinks to spread and dissipate heat) combined with the air duct to transport heated air and heat conducted by the heat sinks outside of the indoor farming environment.

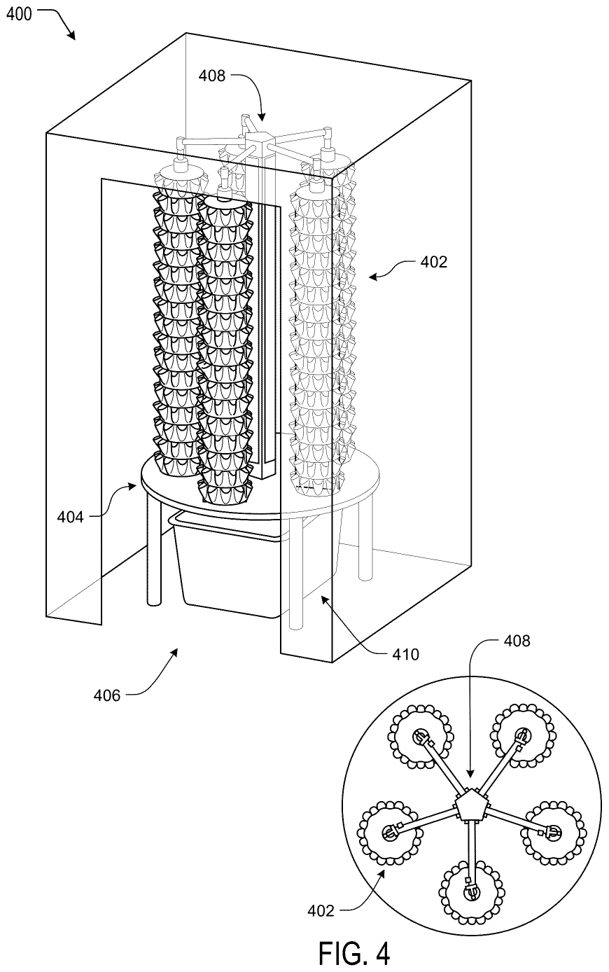

FIG. 4 is an example pictorial diagram of an indoor farming environment 400 according to some implementations. In this example, the indoor farming environment 400 may include multiple planting towers, generally indicated by 402, that may be configured to rotate or otherwise be coupled to a rotatory surface, such as surface 404 in the illustrated example. Thus, in some implementations, the surface 404 may rotate and/or each individual planting tower 402 may rotate. For instance, the surface 404 may rotate to provide ease of access via access area 406 to each of the individual planting towers 402 and each of the planting towers 402 may rotate to provide improved uniformity and customization with respect to lighting and other environmental conditions, as discussed herein.

In this example, a full size access door (not shown) may be associated with the access area 406 to allow an operator access to the interior of the indoor farming environment 400. In this manner, each of the planting towers 402 may be accessed as each of the planting towers 402 may be rotated by the surface 404 to the front or the access area 406 and each planting towers 402 may individually rotate to allow access to receptacles positioned on all sides of each tower 402. The indoor farming environment 400 may also include a fluid distribution system 408 to allow fluid (such as water and/or nutrients) communication between a reservoir 410 with the top of each planting towers 402. In this example, each planting tower 402 may be coupled to the fluid distribution system 408 via a hose or pipe that may be decoupled or blocked (such as via a valve) when the planting towers 402 is not in use.

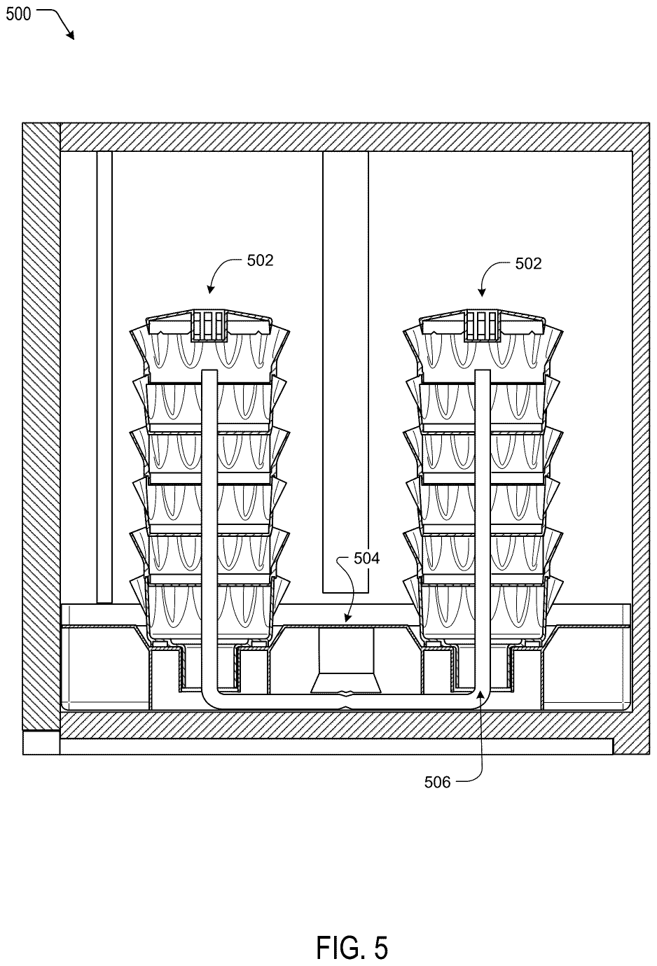

FIG. 5 is an example pictorial diagram of a portion of an indoor farming environment 500 according to some implementations. In some cases, the indoor farming environment 500 may be configured with at least one reservoir to manage water and nutrient quality, nutrients, and chemicals. For example, the indoor farming environment 500 may also include a water control system that monitors and controls intake and output of water. For example, the water control system may include water treatment components (e.g., RO, filter, UVC, and the like), humidity generators and/or condensers, temperature controls, and the like.

In this example, each planting tower 502 may be in fluid communication with a reservoir via a pump 504 and a hose 506 connected to the reservoir in fluid communication with the each of the planting towers 502, such that the water or fluid within the reservoir may be pumped into the growing medium of the seed cartridges during operation and the excess fluid may drain out of the bottom of the planting towers 502 and return to the reservoir, as discussed above. In some cases, each planting column 108 may be configured with an individual reservoir, pump, and/or hose to provide more customized fluids to the plants and vegetation associated with the individual planting tower 502.

In a specific example, the indoor farming environment 500 will need to schedule times for a group of towers to be cleaned while other towers continue growing to allow for a continuous output of plants. This may require multiple reservoirs to allow for continuous cleaning of a specific number of towers 502 while the remaining towers are used for growing. Three reservoirs may be preferred by some farmers to grow, clean, and maintain the systems.

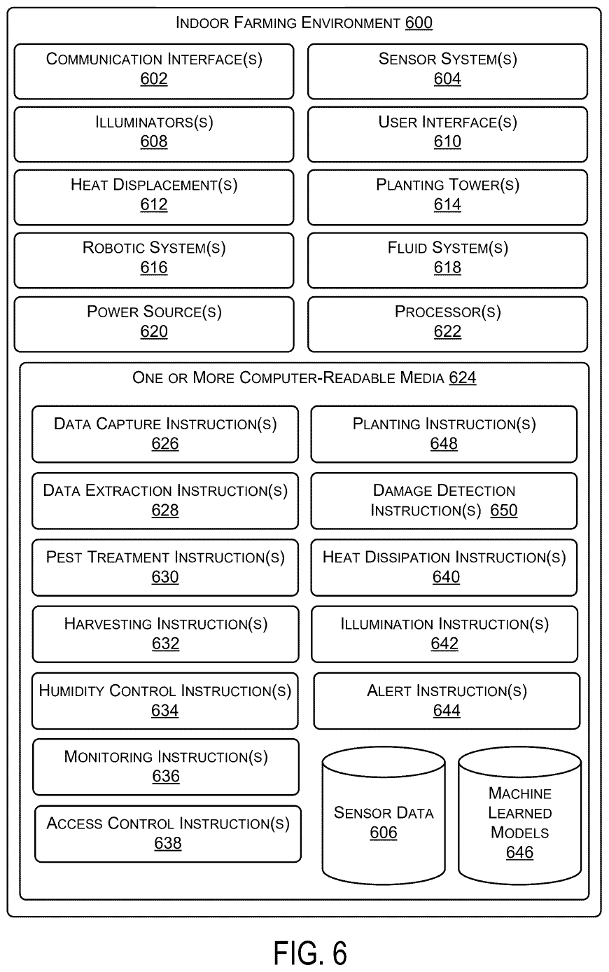

FIG. 6 is an example indoor farming environment 600 that may implement the techniques described herein according to some implementations. The indoor farming environment 600 may include one or more communication interfaces(s) 602 that enable communication between the operator devices, third-party system, the cloud-based management system of FIG. 1, and the like. For instance, the communication interface(s) 602 can facilitate communication with the cloud-based management system to provide sensor data and receive control settings and parameters, as discussed herein. The communications interfaces(s) 602 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor system(s) 604 may be configured to capture sensor data 606 (e.g., image data, temperature data, humidity data, and the like) associated with individual receptacles, planting towers, plants, and the interior of the environment 600. In at least some examples, the sensor system(s) 604 may include thermal sensors, time-of-flight sensors, location sensors, LIDAR sensors, radar sensors, sonar sensors, infrared sensors, cameras (e.g., RGB, IR, intensity, depth, etc.), magnetic sensors, microphone sensors, environmental sensors (e.g., temperature sensors, humidity sensors, light sensors, pressure sensors, etc.), and the like. In some examples, the sensor system(s) 604 may include multiple instances of each type of sensor. For instance, camera sensors may include multiple cameras disposed at various locations.

The indoor farming environment 600 may also include one or more emitter(s) or illuminators 608 for emitting light into the interior of the environment 600, such as by providing customized lighting parameters for individual plants within the interior of the environment 600.

The indoor farming environment 600 may also include one or more user interfaces 610, such as buttons controls, displays, touch enabled displays and the like. In some cases, the user interfaces 610 may be utilized by an operator to control the settings and parameters of the indoor farming system 600, initiate operations (such as pruning, harvesting, planting, cleaning, and the like), monitor conditions of plants or the interior of the indoor farming system 600. The user interfaces 610 may also be used to control access to the interior of the indoor farming system 600.

The indoor farming environment 600 may also include heat displacement systems 612. For example, the indoor farming environment 600 may include manifolds with air ducts and fans to control airflow, humidity, temperature, and the like throughout the interior of the indoor farming environment 600. The system may also include passive heat displacement systems 612 such as heat sinks and the like.

In the current example, the indoor farming environment 600 may include a plurality of planting towers 614. Each planting tower 614 may include a plurality of receptacles for receiving seed cartridges for growing and cultivating of various types of crops and plants. Each tower 614 may be configured to rotate within the indoor farming environment 600 such that each receptacle may be positioned with respect to lighting systems and for operations associated with the robotic system 616.

The robotic system 616 may be configured within the indoor farming system 600. In some cases, the robotic system 616 may be attached to a track along the ceiling or other surface of the indoor farming environment 600 such that the robotic system 616 may move within the indoor farming environment 600 and access each of the towers 614, such as for harvesting, pruning, cleaning, pest eradication, or other operations.

In some examples, the robotic system 616 may include a harvesting component to remove seed cartridges from receptacles of planting towers 614 (such as an electromagnetic component or a magnetic component that may be used to harvest and plant seed cartridges. In some cases, the robotic system 616 of the indoor farming environment 600 may be equipped with illuminators (such as UV illuminators) that may be used to clean or sanitize plants and/or the interior of the environment 600. For example, the indoor farming environment 600 may detect the presence of unsanitary surfaces (e.g., mold, algae, dust, or the like) or the presence of pests within the sensor data 606 generated by the sensors 604. The illuminators of the robotic system 616 may then be used to expose and kill the mold or algae or otherwise clean the interior.

In one example, the robotic system 616 may be equipped with a spraying system with one or more spray nozzles that may apply a chemical treatment or nutrient treatments. In some examples, if one or more planting towers 614 are detected to have a nutrient deficiency, the spraying system may increase the duty cycle of spraying nutrients or water to increase the amount of nutrients released by slow release fertilizer contained within the seed cartridges and, thereby, improve growth of the plants. In some cases, the spraying system may include individual pump actuators or regulating valves per tower. As another example, an electrified component may be placed in proximity to the illuminators (such a illuminators outputting spectra of light designed or known to attract pests), such that as the pests approach the illuminators the pests are zapped or otherwise electrified and thereby eradicated.

As discussed above, a fluid system 618 may be in fluid communication with the towers 614. For example, a water inlet valve and water level sensor (such as ultrasonic, level probes, pulsed radar, capacitive sensing, etc.) fill a water reservoir to supply water and nutrients to the towers 614 with a determined setpoint and desired nutrient ratio. For example, a pump and hose system may be coupled to a reservoir that may be positioned below the towers 614, such that excess fluid drains back into the reservoir. For example, the fluid may be pumped to the top of the towers 614 and allowed to drain down through the grow material of the seed cartridges and the excess returning to the reservoir below the towers 614. In some cases, the fluid system 618 or the reservoir may be accessible via an intake manifold and/or hose that may be filled by an operator on the exterior of the indoor farming environment 600.

A power source 620 may be associated with the indoor farming environment 600. For example, the power source 620 may be a battery, solar collection system, wind power generation system, or the like.

The indoor farming environment 600 may include one or more processors 622 and one or more computer-readable media 624. Each of the processors 622 may itself comprise one or more processors or processing cores. The computer-readable media 624 is illustrated as including memory/storage. The computer-readable media 624 may include volatile media (such as random access memory (RAM)) and/or nonvolatile media (such as read only memory (ROM), Flash memory, optical disks, magnetic disks, and so forth). The computer-readable media 624 may include fixed media (e.g., RAM, ROM, a fixed hard drive, and so on) as well as removable media (e.g., Flash memory, a removable hard drive, an optical disc, and so forth). The computer-readable media 624 may be configured in a variety of other ways as further described below.

Several modules such as instructions, data stores, and so forth may be stored within the computer-readable media 624 and configured to execute on the processors 622. For example, as illustrated, the computer-readable media 624 may store data capture instructions 626 to control the capture of sensor data 606 by the sensor systems 604, data extraction instructions 628 to process and extract data from the sensor data 606, pest treatment instructions 630 to cause pests to be eradicated from the environment or the environment 600 to otherwise be cleaned (such as via the robotic system 616 discussed above), harvesting instructions 632 to cause mature plants to be harvested from the environment 600 (such as via the robotic system 616 discussed above), humidity control instructions 634 may be used to determine current levels of humidity via the sensor data 606 and to adjust humidity accordingly, monitoring instructions 636 may receive the sensor data 606 or parsed sensor data (e.g., segmented, classified, and the like) and to monitor the interior of the indoor farming environment 600 based on the sensor data 606, access control instructions 638 may be used to allow operators, insects or pollinators, or the like access to the interior of the indoor farming environment 600, planting instructions 648 to seed cartridges to be inserted into empty receptacles (such as via the robotic system 616 discussed above), damage detection instructions 650 may utilize the parsed sensor data (e.g., segmented, classified, and the like) to determine any issues or maintenance and repair operations to be performed with respect to the indoor farming environment 600, heat dissipation instructions 640 may control environmental systems (such as the heat displacement system 612) to control the temperature within the indoor farming environment 600, illumination instructions 642 may be configured to control the lighting (e.g., exposure, wavelengths, intensity and the like) used to illuminate each plant within the indoor farming environment 600, and the alert instructions 644 may cause alerts or notifications to be sent to operators and/or third party systems with regards to the plants and/or the indoor farming environment 600, and the like. The one or more computer-readable media 624 may also store one or more machine learned models 646 as discussed herein.

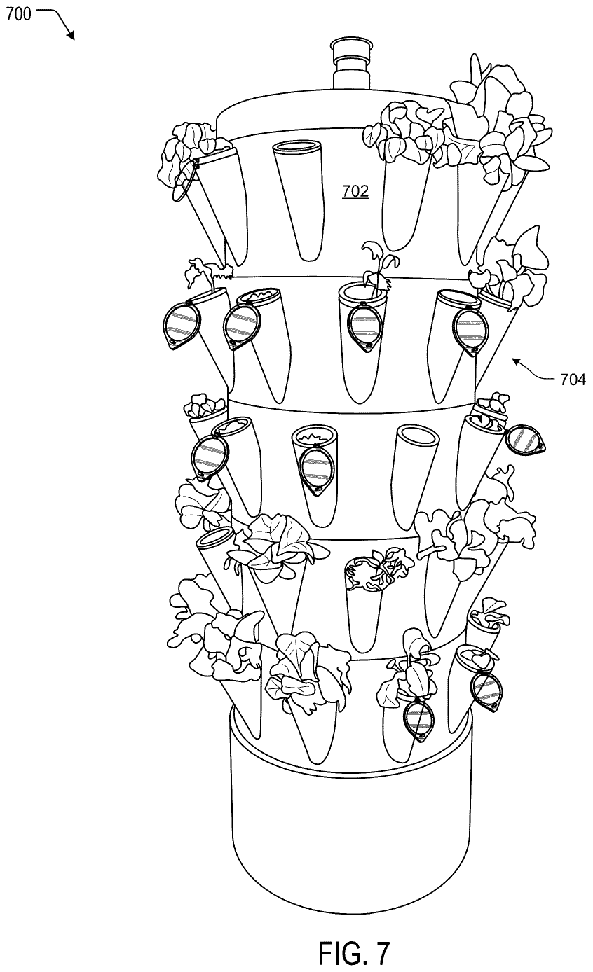

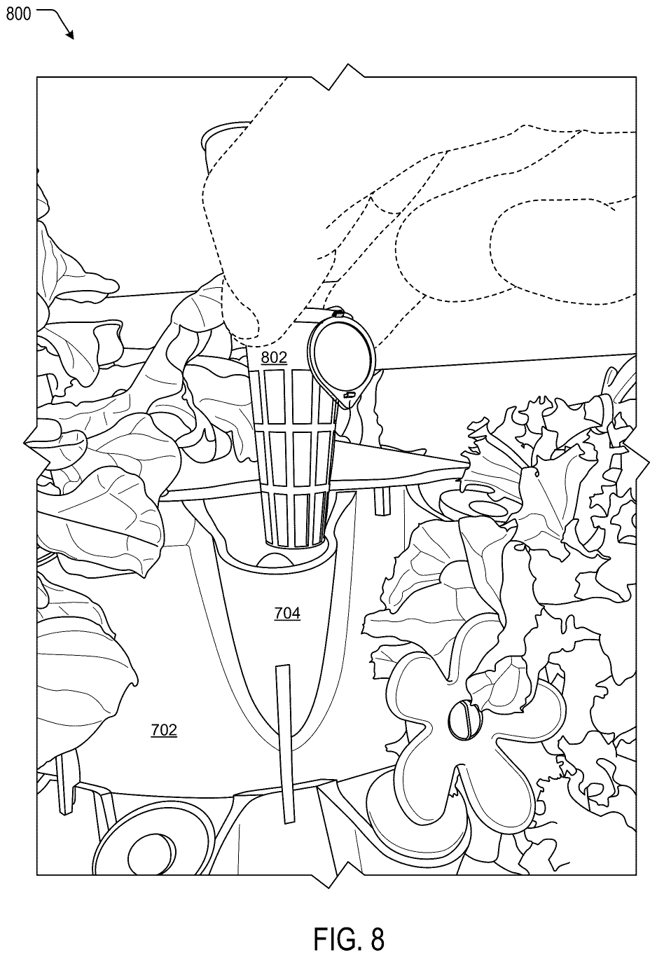

FIGS. 7 and 8 are example pictorial diagrams of an interior of the indoor growing environment with one or more seed cartridges in various stages of germination. As discussed above, a plurality of planting towers 702 may be positioned within the enclosed growing environment. Each planting tower 702 may comprise a plurality of receptacles 704 configured to receive individual seed cartridges 802. The planting receptacles 704 may be arranged both in vertical columns and horizontal rows about the planting tower 702. In some cases, the planting tower 702 may be rotatable three-hundred and sixty degrees within the enclosure and about a base, or any other limited rotation. In some instances, as the planting tower 702 rotates, each individual planting receptacle 704 may be assigned a unique identifier to track each plant based on a determined location (e.g., determined receptacle 704) within the planting column 104. In these instances, the environment may determine the assigned location of a plant upon insertion of an open seed cartridge 802 within a specific planting receptacle.

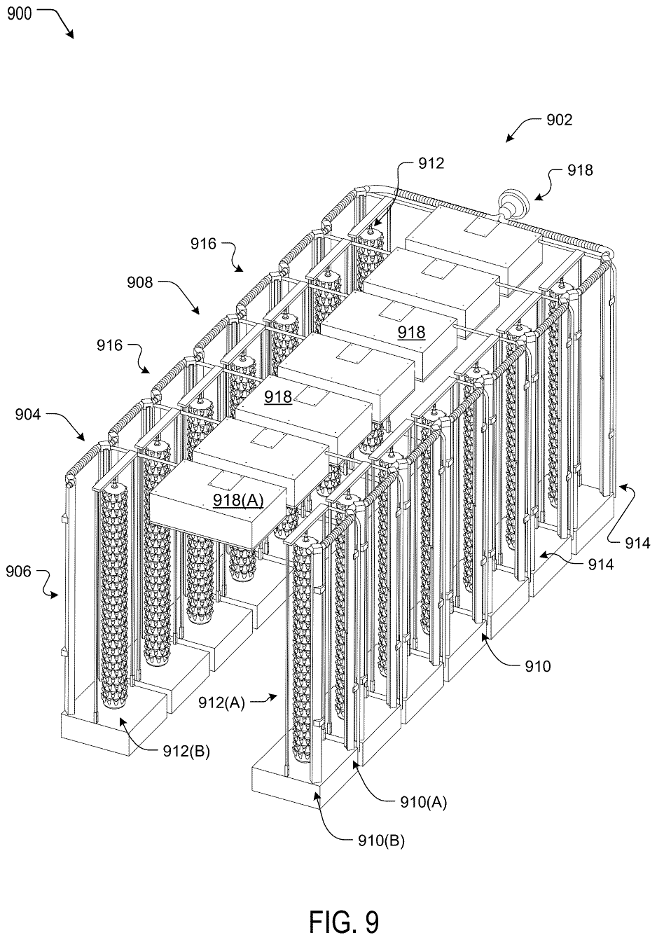

FIG. 9 is an example pictorial diagram 900 of an interior 902 of the indoor farming environment with a heat displacement system 904 having incorporated lighting system 906 according to some implementations. In the current example, the heat displacement system 904 and the lighting system 906 are combined in a joint or combined heat displacement and lighting system 908. The combined system 908 may include one or more vertical lighting arrangements, generally indicated by 910. Each of the lighting arrangements 910 are positioned with respect to a planting towers 912 and configured to provide customized lighting to each plant, plating region, or planting receptacle of the associated planting tower 912. For example, in the current illustrated example, the planting tower 912(A) has two associated lighting arrangements 912(A) and 912(B). It should be understood, that in other examples, different number of vertical lighting arrangements 910 may be associated with each of the planting towers 912. For instance, one lighting arrangement 910 may be associated with each planting tower 912 or four lighting arrangements 910 (such as at four corners of a square configured about the planting tower 912) may be associated with each planting tower 912.

In the current example, each of the lighting arrangements 910 are configured along a vertical air duct, generally indicated by 914. In this manner, air enters the vertical air ducts 914 at the bottom (where cooler air is located within the interior of the indoor farming environment). As the air inside each of the vertical air duct 914 is heated by operations of illuminators (such as LEDs) on the vertical lighting arrangements 910, the heated air rises upward through the vertical air duct 910. The combined system 908 also includes horizontal arrangement air ducts, generally indicated by 916, as shown and at least one exhaust fan 918. The exhaust fan 918 may be configured to provide a vacuum or suction as air is expelled from the interior of the indoor farming environment into an exterior environment to further facilitate the flow of air into the bottom of the vertical air ducts 914 and out of the enclosed growing environment. In some cases, the exterior environment may be a climate control system of a building (e.g., a home, warehouse, office, or the like) to provide highly oxygenated air into the exterior environment.

In the current example, a single exhaust fan 918 is illustrated. However, it should be understood that additional fans (either intake or exhaust) may be used in conjunction with the combined system 908 for maintaining desired temperatures within the indoor farming environment. For example, a second fan (e.g., an intake fan) may be coupled to the air ducts system of ducts 914 and 916 at the opposite end of the indoor farming environment to maintain air flow through the interior of the indoor farming environment from one end to the other.

In the current example, a plurality of electrical enclosures and control systems 918 are shown. In this example, each of the control systems 918 may be associated with a pair of planting towers 912. For example, the control system 918(A) maybe associated with planting towers 912(A) and 912(B). In this manner, the indoor farming environment may be modular such that any number of pairs of planting towers 912 may be used. For example, the length of the indoor farming environment may be variable and accordingly the number of modular pairs of planting towers may be matched to the length of the indoor farming environment. Likewise, if the indoor farming environment can accommodate additional rows, two sets of modules may be arranged horizontally adjacent to each other. In this manner, by having an individual control systems 918 for each module customized electrical and power systems may be voided, thereby reducing installation time and cost while also increasing flexibility of the overall indoor farming environment.

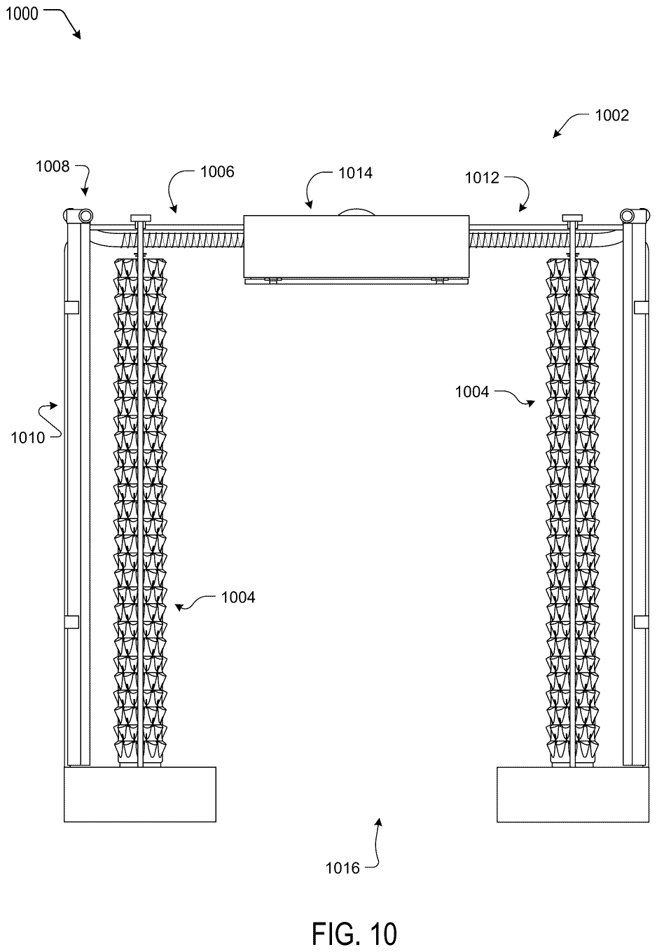

FIG. 10 is an example pictorial diagram 1000 of a module 1002 including a pair of planting towers 1004 with an associated portion of a combined lighting and heat displacement system 1006 according to some implementations. The module includes a pair of planting towers 1004 with space or area 1016 between each tower 1004 for use as a walkway or access area for a human operator or a robotic or autonomous system.

In the current example, the vertical lighting arrangements 1008 associated with each tower 1004 are coupled to the vertical air ducts 1010 to allow air within the air ducts to warm or heat as heat is generated by the operation of the illuminators of the vertical lighting arrangements 1008. In this manner, the illuminators are cooled and the heat generated is prevented from increasing the temperature within the interior of the indoor farming environment. The combined lighting and heat displacement system 1006 also includes horizontal air ducts 1012 which may be coupled to one or more fans (not shown) as discussed above with respect to FIG. 9.

The module 1002 also includes electrical enclosures and control systems 1014. The electrical enclosures and control system 1002 may include wireless or wired communication interfaces for communicatively coupling to a cloud based control system, such as management system 104 of FIG. 1, for receiving control signals, parameters, and settings. The electrical enclosures and control system 1002 may also include power sources (such as a battery system), water and nutrient control systems, climate control systems, and the like.

Although the subject matter has been described in language specific to structural features, it is to be understood that the subject matter defined in the appended claims is not necessarily limited to the specific features described. Rather, the specific features are disclosed as illustrative forms of implementing the claims.

1. An indoor farming environment comprising:
a growing chamber defining an interior enclosure having at least one controllable environmental system;
two or more planting towers configured in rows and columns within the interior enclosure, each of the planting towers having a plurality of receptacles for receiving seed cartridges and configured to rotate about a base;
one or more sensors to capture sensor data associated with plants being cultivated within the receptacles of the plurality planting towers;
a lighting system having first characteristics that are adjustable based on the sensor data to provide customized illumination to each individual plant;
a humidity control system having second characteristics that are adjustable based on the sensor data;
a temperature control system having third characteristics that are adjustable based on the sensor data; and
a nutrient water dosing system having fourth characteristics that are adjustable based on the sensor data.

2. The indoor farming environment of claim 1, further comprising a robotic system including at least one arm for performing operations comprising harvesting plants from the receptacles of the planting towers, pruning the plants, planting seed cartridges within the receptacles of the planting towers, and cleaning of components and environment of the indoor farming environment.

3. The indoor farming environment of claim 2, wherein the robotic system is movable within the interior of the indoor farming environment.

4. The indoor farming environment of claim 3, wherein the robotic system is mounted on a track and may traverse the track to access different plants within the receptacles of the planting towers.

5. The indoor farming environment of claim 1, further comprising:
a manifold for the cultivation of pollinators, the manifold having a first access area to allow an operator in an environment exterior to the interior enclosure to access the pollinators and a second access coupled to the interior enclosure via a passage to allow the pollinators to enter the interior enclosure, the second access having a controllable gate that is closed when the first access is open.

6. The indoor farming environment of claim 1, further comprising a heat displacement system in physical contact with illuminators of the lighting system to transfer heat from the interior enclosure to an exterior environment.

7. The indoor farming environment of claim 1, wherein a group of one or more towers forms a module, each module including a control system in wireless communication with a cloud-based system for controlling the first characteristics of the lighting system.

8. The indoor farming environment of claim 1, wherein the temperature control system includes at least one air intake duct that is coupled to a high carbon-dioxide source and at least one air outtake duct that is coupled to a human accessible area of a building.

9. The indoor farming environment of claim 1, further comprising a communication interface to provide the sensor data to a cloud-based management system and to receive from the cloud-based management system the first characteristics, the second characteristics, the third characteristics, and fourth characteristics.

10. The indoor farming environment of claim 9, wherein the cloud-based management system inputs the sensor data into one or more machine learned models and receives as an output of the one or more machine learned models at least one of the first characteristics, the second characteristics, the third characteristics, and fourth characteristics.

11. The indoor farming environment of claims 1, wherein the first characteristics are selected based at least in part on:
a life stage of a designated plant within the interior enclosure;
a health of the designated plant; and
a class of the designated plant.

12. A method comprising:
receiving sensor data associated with an interior or an indoor farming environment, the indoor farming environment having a plurality of planting towers each having a plurality of receptacles for a cultivation of a plurality of plants and a robotic system for planting and harvesting the plurality of plants;
generating, for each plant of the plurality of plants and based at least in part on the sensor data, one or more parameters for controlling a lighting system of the indoor farming environment, the lighting system configured to provide customized illumination for different regions of the interior of the indoor farming environment; and
providing the one or more parameters to the lighting system of the indoor farming environment.

13. The method of claim 12, wherein the sensor data includes image data of the interior or an indoor farming environment and generating the one or more parameters for controlling a lighting system further comprises:
inputting the image data into one or more machine learned models trained on image data of plants having:
various species, types, and classes,
various indicators of health,
various life stages,
presence of various pests in various different quantities, and
cultivated under different lighting characteristics,
receiving from the one or more machine learned models the one or more parameters.

14. The method of claim 12, further comprising responsive to determining, based at least in part on the sensor data, a first plant of the plurality of plants is ready to harvest, sending control signals and position data of the first plant to the robotic system to cause the robotic system to extract the first plant from a receptacle of the planting tower and to deposit the first plant in a collection area accessible to an operator from an environment exterior to the indoor farming environment.

15. The method of claim 12, wherein each region of the different regions is associated with a single planting receptacle of each planting tower.

16. One or more non-transitory computer readable media storing instructions executable by one or more processors, which when executed, cause the one or more processors to perform operations comprising:
receiving sensor data associated with an interior or an indoor farming environment, the indoor farming environment having a plurality of planting towers each having a plurality of receptacles for a cultivation of a plurality of plants and a robotic system for planting and harvesting the plurality of plants;
generating, for each plant of the plurality of plants and based at least in part on the sensor data, one or more parameters for controlling a lighting system of the indoor farming environment, the lighting system configured to provide customized illumination for different regions of the interior of the indoor farming environment; and
providing the one or more parameters to the lighting system of the indoor farming environment.

17. One or more non-transitory computer readable media of claim 16, wherein the sensor data includes image data of the interior or an indoor farming environment and generating the one or more parameters for controlling a lighting system further comprises:
inputting the image data into one or more machine learned models trained on image data of plants having:
various species, types, and classes,
various indicators of health,
various life stages,
presence of various pests in various different quantities, and
cultivated under different lighting characteristics,
receiving from the one or more machine learned models the one or more parameters.

18. The one or more non-transitory computer readable media of claim 16, wherein the operations further comprise: responsive to determining, based at least in part on the sensor data, a first plant of the plurality of plants is ready to harvest, sending control signals and position data of the first plant to the robotic system to cause the robotic system to extract the first plant from a receptacle of the planting tower and to deposit the first plant in a collection area accessible to an operator from an environment exterior to the indoor farming environment.

19. The one or more non-transitory computer readable media of claim 16, wherein each region of the different regions is associated with a single planting receptacle of each planting tower.

20. The one or more non-transitory computer readable media of claim 16, wherein the operations further comprise generating a control signal to cause a robotic system to harvest one or more plants from the indoor farming environment.
